(19) United States
(12) Patent Application Publication
(10) Pub. No.: US 2023/0405376 A9
(43) Pub. Date: Dec. 21, 2023

(54) AUTOMATED WILDFIRE PREVENTION AND PROTECTION SYSTEM FOR DWELLINGS, BUILDINGS, STRUCTURES AND PROPERTY

(71) Applicant: HAS LLC, Jackson, WY (US)

(72) Inventor: Harry Abraham Statter, Jackson, WY (US)

(21) Appl. No.: 16/289,135

(22) Filed: Feb. 28, 2019

Related U.S. Application Data
(63) Continuation-in-part of application No. 15/804,040, filed on Nov. 6, 2017, now abandoned.
Application No. 15/804,040 is a continuation of application No. 14/805,539, filed on Jul. 22, 2015, now abandoned.
Application No. 14/805,539 is a continuation-in-part of application No. 14/080,326, filed on Nov. 14, 2013, now abandoned.
(60) Provisional application No. 61/726,066, filed on Nov. 14, 2012.

(51) Int. Cl. A62C 3/02; A62C 37/36

(52) U.S. Cl. CPC A62C 3/0214; A62C 3/0271; A62C 37/04; A62C 35/58

(57) ABSTRACT

A fire retardant delivery system for use with a source of carrier for protection from wildfire is provided. The system includes a retardant tank for storing a fire retardant. The retardant tank is in fluid communication with the source of carrier. A metering valve is constructed and arranged to meter a flow of fire retardant injected into the carrier discharged from the source of carrier to maintain a predetermined proportion of fire retardant to carrier, thereby creating a fire retardant and carrier mixture. At least one distribution nozzle is configured to deliver the fire retardant and carrier mixture to a desired area.

### CROSS-REFERENCE TO RELATED APPLICATIONS

This application is a continuation-in-part of U.S. patent application Ser. No. 15/804,040, filed Nov. 6, 2017, which is a continuation-in-part of U.S. patent application Ser. No. 14/080,326, filed Nov. 14, 2013, now abandoned, which claims the benefit of U.S. Provisional Patent Application No. 61/726,066 filed Nov. 14, 2012, the disclosures of all of which are hereby incorporated by reference as if fully set-forth in their respective entireties herein, for all purposes.

### TECHNICAL FIELD OF THE DISCLOSURE

The present disclosure generally relates to the apparatus, techniques, and methods designed to protect structures from wildfire and to control wildfire behavior and direction. More specifically, the present disclosure relates to a fire prevention and protection system for mixing, transferring, and distributing a fire retardant in and to desired areas around and on the exterior surfaces of structures when needed, or in specific areas to impede or redirect the progression of the wildfire.

### BACKGROUND OF THE DISCLOSURE

Wildfires across the United States are increasing in frequency and magnitude. Many authorities are calling 2018 the worst year for wildfires in the history of America. In California, the 2018 wildfire season was the deadliest and most destructive wildfire season on record, with a total of 8,527 fires burning an area of 1,893,913 acres (766,439 ha), the largest amount of burned acreage recorded in a fire season, according to the California Department of Forestry and Fire Protection (Cal Fire) and the National Interagency Fire Center (NIFC). The Camp Fire destroyed more than 18,000 structures, becoming both California's deadliest and most destructive wildfire on record.

Although the relationship between climate change and the incidence of wildfires is speculative, the number of dwellings, buildings, structures, and property at risk is increasing. In the past decade, almost 40% of US homes have been built in the “wildland-urban interface,” or areas where residential neighborhoods border upon forests or grasslands.

This is particularly true in the Central and Western regions of the United States, where wildfires have destroyed thousands of homes and other structures. About $3 billion is spent annually to fight these fires and this figure does not measure the entire economic impact of such fires.

Correspondingly, and as drought conditions continue to spread, the destruction risk from wildfire to residences exists throughout the U.S. and all other forested areas or grasslands in all other parts of the world. Accordingly, this is a global risk without precedent.

As more homes and communities are built along the interface between urban and forested areas, and particularly in areas that are historically burned by wildfires, correspondingly more and more of these structures are directly exposed to the risks of destruction by wildfires. This population and construction trend, coupled with historical timber management practices that have led to increased forest fuel loading in recent decades, and rapidly increasing drought conditions existing across the Central and Western U.S., have led to an unprecedented number of structures being in danger of exposure to, and destruction by, wildfires.

Under certain conditions, conventional methods of fighting wildfires may have little impact when the fires enter the urban-wildland interface where residential subdivisions have been built. Wildfire fighters often can only stand back and watch as homes in the path of a wildfire are destroyed. The inability of wildfire fighters to prevent wildfire from destroying communities has been seen dramatically in the past several years, during which many highly publicized wildfires destroyed thousands of homes throughout the Central and Western U.S., including Arizona, California, Idaho, Nevada, Texas, Oklahoma, Utah and other states.

The costs associated with fighting wildfires pale in comparison to the costs of lost homes and other structures destroyed by wildfires. For example, according to the Insurance Services Office, Inc., the estimated insured losses arising out of the wildfires in San Diego and San Bernadino counties in Southern California in 2003 alone exceeded over $2 billion. Of this, over $1 billion in payments arose out of a single wildfire—the Cedar Fire—which destroyed over 2,200 residential and commercial buildings. On a nationwide basis, the annual insured losses attributable to wildfires for 2012 will be undoubtedly much higher and are known to have exceeded $5 billion by mid-year. The global losses are likely a strong multiple of this mid-year figure and may well exceed $100 billion when finally tallied—which may take some years.

From January 1 to Dec. 22, 2017, there were 66,131 wildfires, as compared to 65,575 wildfires in the same period in 2016, according to the National Interagency Fire Center. About 9.8 million acres were burned in the 2017 period, as compared with 5.4 million in 2016.

In the Napa Calif. fires that occurred during October 2017, there were 8,900 structures burned. Forty-four people lost their lives due to those fires. The estimated insured property loss was $9.4 billion. That estimated insured property loss does not account for the cost to fight the wildfires.

In the December 2017 Thomas Fire in Ventura County Calif., there were 1,300 structures lost and 230,000 people were forced to evacuate. There deaths of two people were attributed to the fire. The insured property loss was estimated at $2.5 billion. In 2017, over one-hundred people died in wildfires that occurred in Portugal and Spain.

Given the staggering amounts of economic and environmental damage caused by wildfires, there is increasing interest in mitigation techniques that reduce the risks to both communities and forested lands.

With respect to homes and business structures, there are several wildfire mitigation strategies that can be taken to alleviate the risk of wildfires destroying dwellings, residences, and buildings. These include relatively simple measures such as using non-combustible materials during construction and establishing an effective “defensible space” or vegetation clearing around homes located in at-risk areas.

Many communities have adopted on a community-wide basis programs to decrease fuel loads around urban-wildland interfaces by aggressively thinning brush and carefully managing controlled “burns.” Good community planning before residential areas are built is important. It may be unwise to locate residential developments in areas that are highly prone to wildfires and are not conducive to defensible space clearing, brush clearing or controlled burns.

Nonetheless, homes, commercial structures and other buildings continue to be built at the edges of the urban areas where the risk of wildfire is the greatest, and even deep in forested areas, much of the time for aesthetic reasons. Accordingly, there is an immediate need for systems that eliminate, reduce or at least substantially mitigate the risk that wildfires will destroy structures such as homes and the like, wherever they are built. The presently disclosed embodiments are directed toward meeting this need.

### SUMMARY OF THE DISCLOSED EMBODIMENTS

One or more techniques may protect a structure from fire. The structure may include a fire suppression system configured to protect the structure and/or a desired area around the structure from the fire. One or more techniques may include determining that the desired area is threatened by the fire based upon one or more factors. One or more techniques may include activating the fire suppression system from an activation location, perhaps for example remote from the wildfire suppression system.

One or more techniques may protect a structure from fire. The structure may include a fire suppression system configured to protect the structure from the fire. One or more techniques may include monitoring a water supply pressure of the fire suppression system. One or more techniques may include monitoring a water supply flow of the fire suppression system. One or more techniques may include determining that a fire suppression system demand exceeds a threshold, perhaps for example based on at least the water supply pressure and/or the water supply flow. One or more techniques may include changing a flow of a fire retardant of the fire suppression system to at least a first surface of the structure, perhaps for example upon the determining the fire suppression system demand exceeds the threshold.

One or more techniques may protect a plurality of structures from fire. One or more, or each, of the plurality of structures may include a fire suppression system that may be configured to protect the one or more, or each, of the plurality of structures from the fire. One or more techniques may include monitoring a water supply pressure of one or more of the plurality of fire suppression systems. One or more techniques may include monitoring a water supply flow of the one or more of the plurality of fire suppression systems. One or more techniques may include determining that a fire suppression system demand for the one or more of the plurality of fire suppression systems exceeds a threshold, perhaps for example based on the water supply pressure of the one or more of the plurality of fire suppression systems and/or the water supply flow of the one or more of the plurality of fire suppression systems. One or more techniques may include determining which of the one or more of the plurality of fire suppression systems is directing a flow of fire retardant to at least one vertical surface of a structure respectively associated with the one or more of the plurality of fire suppression systems. One or more techniques may include changing the flow of fire retardant directed to the at least one vertical surface for one or more, or each, of the determined one or more of the plurality of fire suppression systems, perhaps for example upon the determining the fire suppression system demand exceeds the threshold.

One or more techniques may protect a plurality of structures from fire. One or more, or each, of the plurality of structures may include a fire suppression system that may be configured to protect the one or more, or each of the plurality of structures from the fire. One or more techniques may include determining a first set of one or more of the fire suppression systems that are proximate to a perimeter of an active fire region. One or more techniques may include determining a second set of one or more of the fire suppression systems, perhaps for example that are more distant to the perimeter of the active fire region relative to the first set of the one of more fire suppression systems. One or more techniques may include changing a flow of water directed to the second set of one or more of the fire suppression systems.

One or more techniques may estimate risk of exposure to fire for one or more regions of a geographic territory. One or more techniques may include determining a first fire risk rank for at least one region of the one or more regions, perhaps for example based on one or more current atmospheric conditions corresponding to the at least one region. One or more techniques may include determining one or more fire characteristics of the at least one region, perhaps for example, based at least on one image of the at least one region. The at least one image may have been captured after a temporally recent past fire in or near the at least one region. One or more techniques may include determining a number of fire suppression systems located in or near the at least one region. One or more techniques may include determining one or more ember hazard effects for the at least one region. One or more techniques may include adjusting the first fire risk rank to a second fire risk rank, perhaps for example based on the number of fire suppression systems, the one or more ember hazard effects, and/or the one or more fire characteristics. One or more techniques may include determining an evacuation condition, perhaps for example based on the second fire risk rank. One or more techniques may include communicating the evacuation condition to one or more recipients.

### BRIEF DESCRIPTION OF THE DRAWINGS

The embodiments described herein will be better understood and its numerous objects and advantages will be apparent by reference to the following detailed description of the embodiments when taken in conjunction with the following drawings.

FIG. 1 is a schematic top plan view of a residential structure and the area surrounding the structure, illustrating one embodiment of the fire retardant distribution system according to the present embodiments.

FIG. 2 is a schematic layout view of the fire retardant distribution system shown in FIG. 1 with the structure removed to illustrate the system.

FIG. 3 is a schematic view of the primary systems according to one embodiment, including the distribution system, the storage system and the control system.

FIG. 4 is a schematic view of the control system according to one embodiment.

FIG. 5 is a schematic top plan view of a perimeter fire retardant distribution system according to a second embodiment.

FIG. 6 is a schematic view of another primary system according to one embodiment, including the distribution system, the storage system and the control system.

FIG. 7A is a schematic view of another primary system according to one embodiment, including the distribution system, the storage system and the control system.

FIG. 7B is a schematic view of another primary system according to one embodiment, including the distribution system, the storage system and the control system.

FIG. 7C is a schematic view of another primary system according to one embodiment, including the distribution system, the storage system and the control system.

FIG. 7D is a schematic view of another primary system according to one embodiment, including the distribution system, the storage system and the control system.

FIG. 8A is a schematic view of a containment module according to one embodiment.

FIG. 8B is a schematic view of a containment module according to one embodiment.

FIG. 9 is a schematic view of a control system according to one embodiment.

FIG. 10 is an example topography illustration indicating an assessment of fire-hazard zones.

FIG. 11 is an example diagram of a computer/processing device wherein one or more of the concepts of the disclosure may be implemented.

### DETAILED DESCRIPTION OF THE DISCLOSED EMBODIMENTS

In some embodiments, a fire retardant distribution system is disclosed for use on any type of structure including residences, out buildings, barns, commercial buildings, and other structures and their associated surrounding landscapes, to name just a few non-limiting examples. The system is designed to prevent structures from catching fire when a wildfire approaches, and relies upon a spray system that when activated quenches and coats the exterior of the structures, decks and surrounding landscape very rapidly with a fire retardant that remains on the surface until washed off. In some embodiments, the system is self-contained and relies upon tanks pressurized by a motive source such as inert gas, combustible fuel, electric, gravity, pump, or another power source to deliver the fire retardant to spray valves positioned on and around the structures. The motive source is operatively coupled to the retardant tank and the source of carrier. In other embodiments, the motive source of the system comprises water lines that are pressurized through municipal water systems or the pumping mechanism from water wells to provide water and pressure to the system.

There may be no need for electrical power in some embodiments, although electrical power may be supplied by a battery backup system, uninterruptible power supply, or other source of local electrical energy if an electrically operated control system is used. The system may be activated manually, or may optionally include a control module that allows the system to be activated in any number of ways, including inputs by manual activation, remote telemetry and by remote access (such as by DTMF telephone, mobile device application, or internet link, to name just a few non-limiting examples). The system may be activated by a remote access (for example, using a satellite link). The system may be activated by/through one or more machines/devices or other non-human intervention. The one or machines/devices may be self-learning. The one or more machines/devices may learn (e.g., automatically) and/or may make adjustments in determining system activation. For example, the one or more machines/devices may learn and/or determine one or more activation triggers for system activation. The one or more machines/devices may learn and/or determine a desired area for protection that may be threatened by a fire, perhaps for example based upon one or more factors.

Other embodiments are directed toward blocking or re-directing the progress of a wildfire, and comprise a pump powered by combustible compressed fuel, electric, or other power source that is connected to a reservoir of non-pressurized retardant and a series of distribution devices connected to the outflow of the pump. The distribution devices are positioned to spray the fire retardant in a line or arc that either blocks progress of a wildfire, or channels or blocks the direction of the fire in a desired manner. Several subsystems, each comprising a pump and the associated distribution devices may be laid out in series so that a fire retardant protection line several miles long may be quickly laid down on vegetation. This “flanking” technique allows wildfire fighters to control fire direction and behavior at critical points, typically near communities.

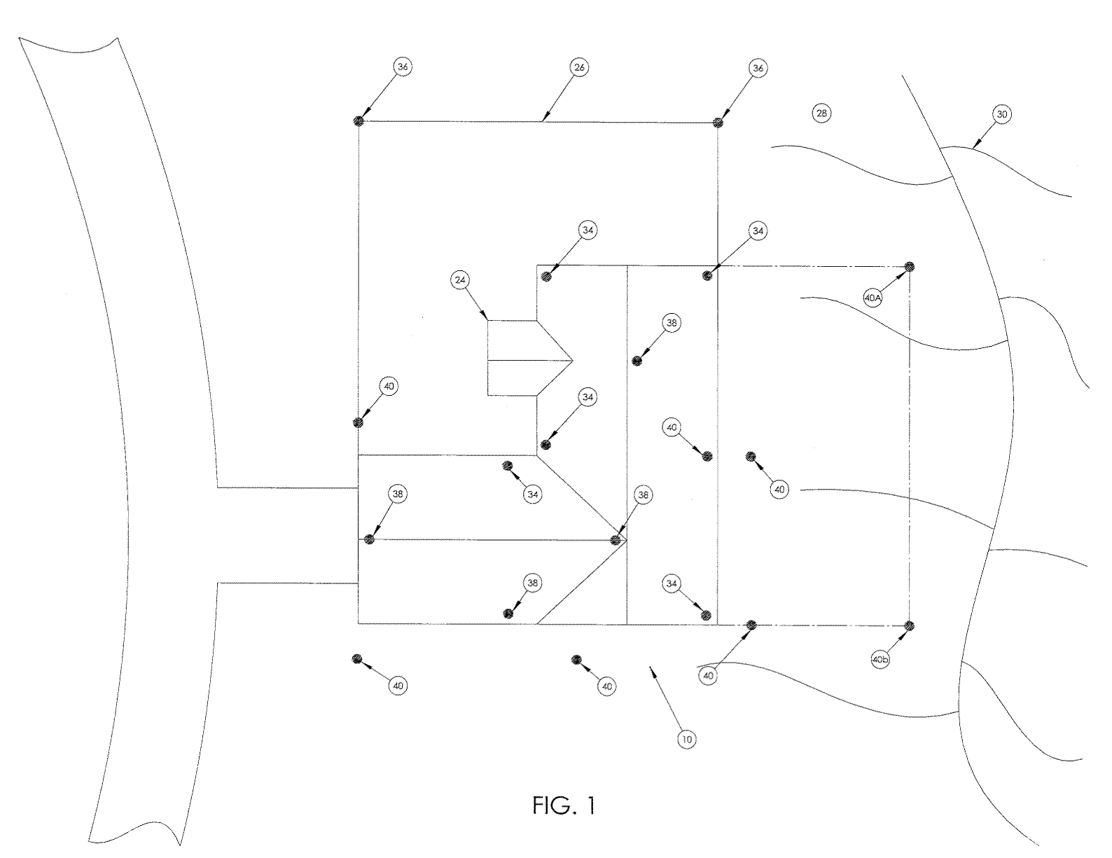

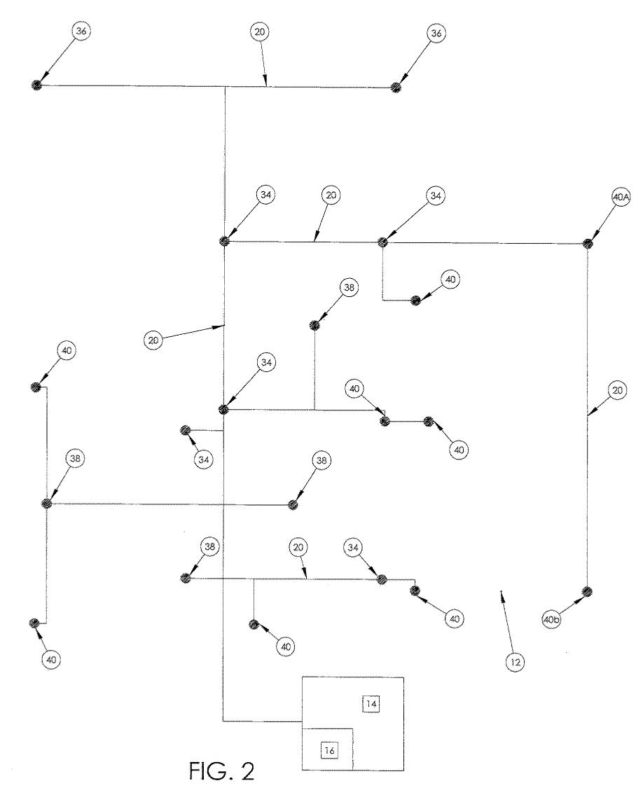

With reference to FIGS. 1, 2, and 3, a fire retardant distribution system 10 is illustrated schematically in a typical installment in a residential setting that includes a building 24 such as a typical home located near an urban-wildfire interface area. The system illustrated in FIGS. 1 and 2 is only an illustrative example, and those skilled in the art will recognize from the present disclosure that many other configurations are possible and will be configured depending upon the desired area to be protected. In one embodiment, the desired area is defined as an area between a structure and at least one historical fire originating location. In one embodiment, the desired area is defined based upon temperature inputs from real-time remote telemetry 73. In one embodiment, the desired area is defined based upon relative humidity inputs from real-time remote telemetry 73. In one embodiment, the desired area is defined based upon wind patterns inputs from real-time remote telemetry 73. In one embodiment, the desired area is defined based upon historical fire data and/or historical fire patterns. In one embodiment, the desired area is defined based upon fuel distribution patterns (e.g., of vegetative plant communities and/or of patterns of structures). In one embodiment, the desired area is defined based upon a perimeter of a (e.g., actively burning) fire. In one or more embodiments, the desired area may be defined based upon one or more of: smoke detection, flame detection, fire gas detection, volumetric sensing, video imaging sensing, multimodal object recognition, one or more occurrences of a structure/building/house fire, and/or one or more occurrences of fire(s) burning within a (e.g., set and/or predetermined) radius. For example, one may correlate predetermined densities of fuels which lead to high burn intensities, with other characteristics such as red flag warning days or temperatures which also lead to high burn intensities, with other characteristics such as population which could be indicative of higher human caused triggers of fire. Regardless of the density of homes and the potential for a burn, there still needs to be a fire start. Looking at a multimodal approach may find correlation amongst the commonly found variables and thereby better define high risk areas/areas to install fire suppression systems.

One or more monitoring/suppression techniques may include remote monitoring, activation (e.g., activation triggering), and/or wildfire management. One or more monitoring/suppression techniques may remotely monitor an individual structure and/or an entire region with one or more, or multiple, structures. Such remote monitoring may be accomplished without firefighting personnel “on the ground”, for example. One or more monitoring/suppression techniques may consider local conditions (e.g., wind and/or weather forecasts, etc.). One or more monitoring/suppression techniques may triage areas that have a risk (e.g., a highest risk) and/or an exposure (e.g., serious and/or material exposure) to damage from wildfire activity.

One or more monitoring/suppression techniques may protect one or more, or multiple, areas and/or sites threatened by an active wildfire. For example, evidence appears to suggest that embers may be a significant (e.g., primary) cause of the spread of wildfire and the ensuing loss of life and/or the destruction of property. Perhaps for example under the right conditions, embers from an active wildfire can travel over five miles. Such embers may ignite houses/structures/buildings that may have been thought to be in low risk areas. One or more monitoring/suppression techniques may monitor wildfire activity within one or more regions and/or provide preventive wildfire suppression within and/or near to the one or more regions.

The system 10 includes several different components or subsystems, including a fluid-based distribution system shown generally at 12 and comprising the pipes and nozzle systems through which the fire retardant is delivered to and applied on surfaces, a carrier (such as water or other fire retardant carrier) and fire retardant storage system shown generally at 14 and comprising the storage tanks for storing separately both the carrier and the fire retardant when the system is not in use, and pressurization tanks for pressurizing the system and associated hardware, and a control system shown generally at 16 and comprising generally the devices necessary for activating the distribution system 10. Each of these components is described in detail below.

The system 10 shown in the figures illustrates a typical residential installation in which the system is configured to deliver the water based fire retardant to the exterior surfaces of the building 24, a deck 26 attached to the building, and surrounding areas such as landscaping 28. In FIG. 1, the building is shown located adjacent to a canyon area 30 to illustrate both structure protection and possible “flanking” distribution.

The distribution system 12 is shown in isolation in FIG. 2 and comprises a system of pipes 20 and distribution spray nozzles connected to the pipes at engineered positions. The distribution system 12 illustrated herein also includes pipes 20 extending to the edge of the canyon area 30. The type and size of piping 20 used in a distribution system 12 depends on factors such as the size of the system and the amount of water and retardant that will be delivered through the system. Generally, any type of UV resistant tubing will work well for the pipes 20 used in system 12, including for example polyvinylchloride (PVC) pipe, polyethylene tubing, copper tubing, galvanized pipe, or steel pipe, to name just a few non-limiting examples. With some combinations of metallic pipe and fire retardant, care must be taken to avoid corrosion of the pipes caused by the particular retardant that is used. The diameter of the pipe 20 also depends on the volume and the operating pressure of fire retardant delivered through the system.

The pipes 20 and associated distribution spray nozzles define a distribution system 12 for the fire retardant contained in the storage system 14. The piping is connected to the various source tanks for the fire retardant as described below and is plumbed through the walls of the structure or is buried underground. In some embodiments, the piping 20 is installed during initial construction of the building 24 so that it may be installed in an “in-wall” manner for aesthetic purposes, under sheet rock and the like. However, the system 10 may often be retrofitted into existing buildings, in which cases the piping 20 may be run under eves and the like in a manner designed to be as inconspicuous as possible, while maintaining convenient access for maintenance purposes.

The distribution system 12 may include several different types of distribution spray nozzles. Each nozzle has a specified purpose. For example, exterior wall nozzles 34 are located at strategic positions along the perimeter of the building 24 so that the exterior surfaces of the building 24 are coated with fire retardant when the system is activated. Thus wall nozzles 34 are mounted under the eves or overhangs of building 24 and are configured to direct a sprayed stream of fire retardant onto the exterior walls of the building. There are six wall nozzles 34 shown in FIGS. 1 and 2, but as many wall nozzles are plumbed into the system as are necessary to uniformly coat the entire exterior wall surface area (or as much thereof as is practical). In some embodiments, wall nozzles 34 may be mounted approximately every 30 lineal feet along the length of the wall, but the separation may be more or less depending upon system design specifics.

Likewise, the system 10 shown in FIGS. 1 and 2 includes two deck nozzles 36 located around deck 26. These deck nozzles direct a spray of fire retardant onto the horizontal surface of the deck and if desired, may be the type of nozzles that rotate through a complete circle so that they also deliver fire retardant to adjacent landscape areas.

In FIGS. 1 and 2 there are four roof nozzles 38 situated so that they spray the entire roof surface. And the system 10 shown in FIG. 2 includes nine separate landscape nozzles 40 positioned around the landscaping 28, two of which (labeled 40a, 40b) are positioned adjacent to the canyon area 30. It will be appreciated that in some embodiments the pipe 20 is buried underground in the landscaped areas for many reasons, including aesthetic, climate protection and damage control.

Each of the nozzles used with system 10 is of a type appropriate for the specific location. In some embodiments, wall nozzles 34 typically are misting or flat sheet spray nozzles having about ½ inch diameter. These nozzles are mounted in some embodiments under the eaves of the building such that the nozzles protrude about 1 and ½ inches from the eave. These nozzles may be plastic, stainless steel, or brass, to name just a few non-limiting examples. In some embodiments, these nozzles do not rotate but instead direct a spray, stream, arc or mist directly onto the vertical walls of the building. Nonetheless, in other embodiments these nozzles may be configured to rotate when they are pressurized to thereby spray fire retardant onto adjacent surfaces such as soffits, decks and the surrounding exterior ground.

In some embodiments, the deck nozzles 36 may be of the type typically seen in in-ground irrigation systems, such as pressure pop-up rotating sprinkler nozzles. These nozzles may be set to rotate through a complete 360° circle, or only part of a circle. In other embodiments, impact driven sprinkler nozzles may also be used for the deck nozzles.

Roof nozzles 38 may be of the spray or impact type. In many embodiments, all nozzles in system 10 are mounted so that they are either concealed or minimally visible when not in use so as not to detract from the aesthetic appearance of building 24. Thus, retractable type distribution nozzles may be mounted in the ground or in special boxes mounted on the deck, for example. Similarly, the roof nozzles 38 may be mounted in architectural features on the peak of the roof such as cupolas or dormers. The cupola may be built to include blowout louvers and similar fittings that are instantly blown out when the fire retardant begins spraying out of a nozzle. A cupola also may be built to accommodate a retractable sprinkler head for use in the roof nozzle 38. Regardless of the type of nozzle used, there are sufficient roof nozzles 38 located along the peaks and ridges of the building's roof so that the entire roof is sufficiently and uniformly coated with fire retardant as to prevent and protect substantially the potential wildfire damage.

Similarly, the landscape nozzles 40 are selected to be of a type that is appropriate to the particular location. Pressure operating, retractable distribution nozzles are used in some embodiments, but other distribution heads also work well. With respect to the two landscape nozzles 40a and 40b located adjacent to the edge of the canyon area 30, these are in some embodiments impact heads, or “gun” type agricultural heads more commonly used to irrigate row crops.

In many embodiments, the distribution system 12 is not charged with fire retardant when the system is not in use. In other words, the pipe 20 is empty when the system is not in use. This eliminates any problems with freezing or corrosion from the fire retardant resident in the pipes (in combinations where this is a concern).

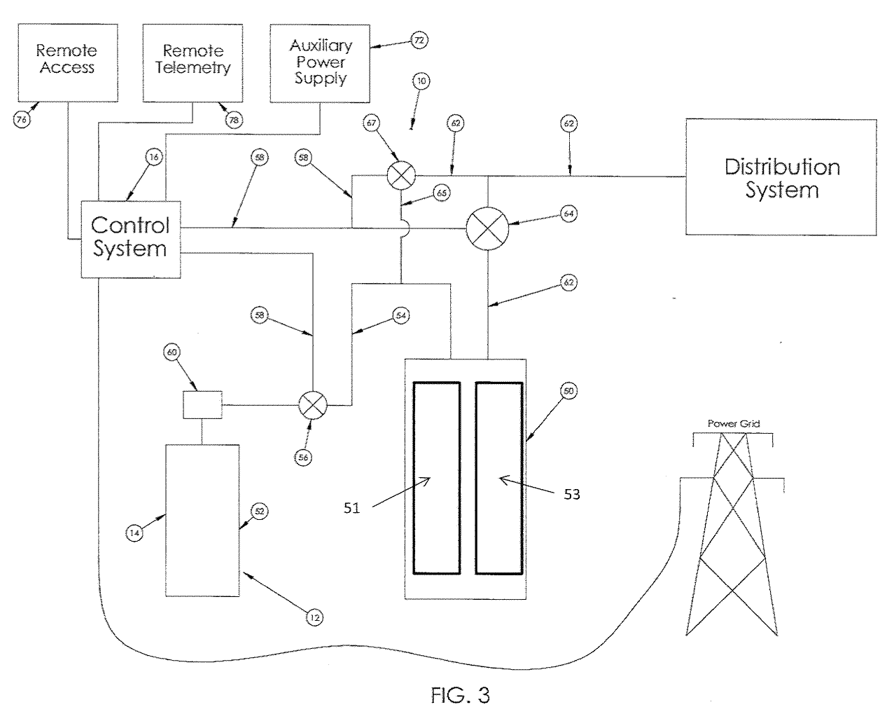

The storage system 14 will now be described in detail with particular reference to FIG. 3. In FIG. 3, the distribution system 12, storage system 14 and control system 16 are shown schematically. Storage system 14 comprises one or more water or other carrier based fire retardant tanks, pressurization systems, and control valves for operating the system. Specifically, the storage system 14 illustrated in FIG. 3 typically utilizes a double tank arrangement 50 and a single pressurization tank 52. In some instances the double tank arrangement will be modified to include either a single tank or some multiple of the double tank arrangement. Alternatively, in some instances, as shown in FIG. 6, the system relies on a carrier from a source other than a tank such as a water well, municipal water supply, pond, water well, water tank, lake, or any other such water supply source that is used to provide a carrier that is fluidly coupled with a fire retardant from a tank. Hereinafter said tank arrangements will be referred to as “double tank arrangement 50”. The double tank arrangement 50 contains both water or other carrier and the fire retardant, separated for storage purposes into a carrier tank 51 and a retardant tank 53. During storage, the carrier and the fire retardant are stored in a non-pressurized state. The size and volume of said tanks 50 varies according to the size of system 10. The double tanks 50 are sized so that the tanks have adequate volume to spray the desired volume of the fire retardant mixture uniformly over the entire area intended to be covered by the system 10. A variety of tank types may be used for the double tank arrangement 50. For example, double tank arrangement 50 may be fiberglass reinforced plastic, HDPE or steel, lined appropriately with corrosion resistant materials, to thereby prevent corrosion in the tanks which may impair system function when needed for fire suppression purposes. In a typical residential installation, the double tank arrangement 50 has a combined capacity of about 100 to about 350 gallons or larger. Larger tanks of up to 10,000 gallons or more may be used with large structures or where retardant is to be sprayed over a large area or in community-based systems.

Some kinds of fire retardants that may be used in system 10 tend to stratify or chemically separate over time, rendering them inactive or ineffective. Depending upon the type of fire retardant used, the double tank arrangement 50 may be fitted with agitators such as bubbler or paddle-type mixers to keep the fire retardant homogenous and active or useful over time. A secondary bubbling line (not shown) may be run from the pressure tank 52 into the fire retardant tank 50 to cause either continuous or intermittent bubbling of nitrogen or other gas, which is sufficiently chemically inert to be useful and practical, through the fire retardant to mix the fire retardant and thus prevent stratification. The control system 16 may be configured to provide bubbling into the fire retardant tank itself when the system 10 is either activated or when stratification is suspected or to prevent stratification by time cycle operation.

The double tank arrangement 50 is plumbed to pressure tank 52 through a pressure line 54. A valve 56 is in pressure line 54 and is, as detailed below, connected to and operable under the control of control system 16 through control line 58. A pressure regulator 60 with a vent is provided to regulate the pressure in pressure tank 52. A system flush pipe 65 branches from pressure line 54 and connects to outlet pipe 62 upstream from valve 64. A valve 67 is plumbed into flush pipe 65. The system flush pipe 65 is explained below.

In some embodiments, pressure tank 52 may be a commercially available cylinder or set of cylinders charged with an inert pressurized gas such as nitrogen that serves as the motive force for the system 10 to deliver the water based fire retardant through pipes 20 to the various nozzles. Pressure tank 52 is of a sufficient volume and is charged to an appropriate pressure such that when the system 10 is activated, all or a portion of the fire retardant mixture contained in the double tank arrangement 50 may be delivered through the nozzles at an operating pressure appropriate to the system—about 50-60 psi in some embodiments. A pressure regulator is typically used to regulate the operating pressure of gas delivered from pressure tank 52 to the double tank arrangement 50 and the nozzles downstream of the tank 50. In some embodiments, the double tank arrangement 50 is capable of being pressurized up to about 120 psi or less.

Upon actuation of the system 10 the fire retardant and the carrier are mixed into a fire retardant and carrier mixture. Fire retardant contained in the double tank arrangement 50 is delivered to the piping 20 on FIG. 2 of distribution system 12 through an outlet pipe 62. As noted, a valve 64, which is under the control of the control system 16 through control line 58, is plumbed into outlet pipe 62 near the double tank arrangement 50.

In one embodiment, as shown in FIG. 6, the double tank arrangement 50 in FIG. 3 may be limited to a single or multiple tank arrangement of fire retardant in which case the carrier is not contained within a tank. In such a non-limiting example, the carrier is provided through another source 55 such as a water well, municipal water supply, pond, water well, water tank, lake or any other carrier source available piped to the fire retardant tank or tanks through a piping system. In such a non-limiting example, the other carrier source is fluidly coupled to the single or multiple tanks of fire retardant and delivered to the piping on FIG. 2 of distribution system 12 through an outlet pipe 62.

In installations of system 10, the storage system 14 on FIG. 2 may be located in any appropriate setting such as in a garage, HVAC area, out building or constructed pad.

It will be appreciated that storage system 14 may utilize multiple double tank arrangements 50 and multiple pressure tanks 52 if the size of the system 10 is sufficient to warrant the capacity achieved by additional tanks.

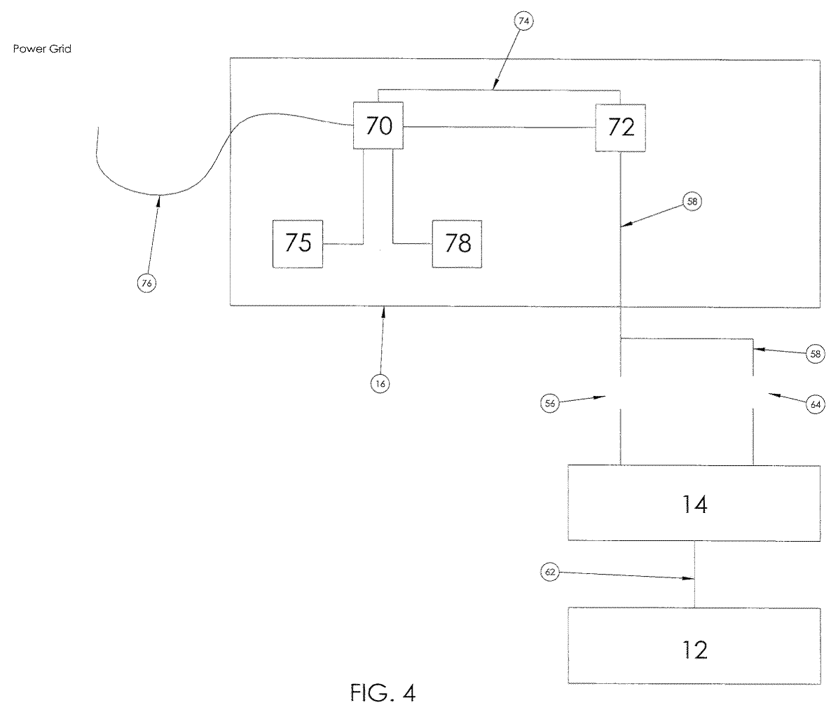

Control system 16 (or activation system 16) is shown schematically in detail in FIG. 4 and includes an activation switch 70, which is typically an electronic switch such as a solenoid or mechanical relay or the like, and an auxiliary power supply 72 such as an external battery and/or uninterruptible power supply module. The control system 16 is operably coupled to the motive source and operable to actuate the motive source. Activation switch 70 is the main on/off switch for activating system 10 and is normally powered by the power supply to the building or location. However, in wildfire situations electric power from public utilities and the like may be cut off. Auxiliary power supply 72 provides electric power to activation switch 70 through wiring 74 to ensure that activation switch 70 is powered under all circumstances, even where the external electrical power supply has been interrupted. As indicated earlier, control lines 58 interconnect control system 16 to valves 56 and 64, which preferably are electrically operated solenoid valves. Alternately, all of the valves described herein may be operated pneumatically, hydraulically or manually (to name just a few non-limiting examples), depending on the type of system that is being used.

Activation switch 70 is operable under a variety of input systems that are capable of activating system 10. For example, switch 70 may be activated with a manual switch 75 that is located in, on or adjacent to the building 24. If a wildfire is approaching the building, the manual switch 75 is activated to begin activation of the system 10.

Activation switch 70 is further operable via coded remote activation/access 76 such as an internet portal access, mobile device application or as a coded series of tones (such as DTMF tones generated by a telephone handset) as may be desired. Thus, control system 16 may include a telephony systems wire to the landline, cellular or satellite phone systems so that switch 70 may be remotely operated by calling a specific telephone number and entering codes manually or automatically. The building owner, the local fire departments, etc. may use the coded remote access 76 by dialing the number, activating the applications or suitably transmitting a code or signal. Switch 70 may also be operated by on-site detectors 78 such as infrared, smoke, temperature, and/or other fire detectors located around the building, or by similarly situated RF or IR or laser controlled devices. For example, an infrared detector may be located near the edge of canyon area 30. If a wildfire is detected, the detector is capable of activating switch 70. Similarly, heat sensors and other types of similar sensors may be located around or near a building, or near the edge of canyon area 30 and configured for activating system 10.

The fire retardant used in system 10 is in some embodiments a liquid, gel or powder that when properly combined or mixed with water or other carrier flows readily through the plumbing systems and through the nozzles. Because the retardant component may not be used for several years after double tank arrangement 50 is filled, in some embodiments the retardant is not prone to degradation in effectiveness over time. Because the fire retardant is sprayed over buildings, in some embodiments the retardant does not discolor building surfaces, does not harm vegetation, and causes no other environmental damage. A wide variety of fire retardants suitable for use in system 10 are commercially available and may be selected on a project-by-project basis. By way of non-limiting example, fire retardants may comprise a foam, a Class A foam, or firefighting foam, as well as fire retardants marketed commercially under the brand names Buckeye Platinum Class A foam fire suppressant, Barricade, Phos-Chek, TetraKO, and FireIce may be used. In some embodiments, the fire retardant applied may be simply water, either from the beginning of application of fire retardant, or after such time as another fire retardant has been exhausted by the system. Therefore, as used herein, “fire retardant” is intended to encompass water, foam, foam/water mixture, or any other substance that will suppress or extinguish fire.

Operation of system 10 will now be detailed. When system 10 is not in use, or “idle”, the fire retardant double tank arrangement 50 is substantially filled with water or other suitable carrier and the fire retardant respectively but is not pressurized; alternatively, a single tank or multiple tanks may be filled with fire retardant and a suitable carrier is provided through any other suitable source of carrier (not within the tank(s)). Valves 56, 64 and 67 are closed. System 10 is activated in any number of the ways detailed above. For purposes of illustration, in this case it is assumed that the system 10 is installed in a residential structure and authorities, because of the threat posed by an approaching wildfire, have evacuated the resident of the structure. In other words, the system 10 was not activated prior to the building being evacuated. When the owner deems that the structure is imminently threatened by wildfire, the owner accesses the system by the Internet, smart phone application or calls the number for the coded remote activation/access 76 of control system 16 on either a WiFi portal, landline, cellular or satellite phone. The coded remote activation/access 76 is configured to respond to the incoming access signal and will prompt the caller to activate switch 70—that is, to turn switch 70 from the “off” to the “on” position. For example, the coded remote activation/access 76 may prompt the caller to enter an authorization code such as a user name and password or numeric code to first insure that the caller is authorized to give the system further instructions. If the correct user name and password or numeric code is entered, the coded remote activation/access 76 will next prompt the caller to a specific activation code or selection from a menu that may include status checks, inputs from sensors or to activate the activate switch 70. The authorization code may comprise a fingerprint and/or facial recognition.

When the caller enters the activation code, control system 16 sends appropriate signals to valves 56 and 64, which as noted are electrically operated valves such as solenoid valves, causing the valves to open. As valve 56 opens, gas from the pressure tank 52 flows into and pressurizes the double tank arrangement 50. With valve 64 open, both the water and fire retardant begins flowing into outlet pipe 62 under the pressurizing force applied by gas from pressure tank 52, and thus into the entire distribution system 12. Proportional measures of both carrier and the fire retardant are maintained by pre-set pressures or other such mixing systems such as injector, venturi eduction, injection pitot etc. The mixing system may contain multiple points of injection, venturi eduction, injection pitot, etc. The now blended or mixed fire retardant flows quickly into pipes 20 and begins to be discharged from each of the nozzles in the system. Although the nozzles in the system are configured to apply the desired amount of fire retardant onto adjacent surfaces, a typical application rate is between the range of 0.5 and 5 gallons per 100 square feet of surface. The desired amount may be calculated by the control system at the time of activation with inputs from remote sensors or the owner/operator. Additionally, this application rate may vary with the type of fire retardant used.

The fire retardant is sprayed out of the nozzles onto the intended surfaces until either the entire volume contained in the double tank arrangement 50 is sprayed through the nozzles, or the system is deactivated by deactivating switch 70—that is, the switch 70 is moved from the “on” to the “off” position which is dependent on the type of switch selected by the design process. In this regard, in some embodiments pressure tank 52 contains enough pressurized gas to discharge the entire contents of fire retardant contained in the double tank arrangement 50 when said double tank arrangement 50 is full, and to clear all fire retardant contained in all plumbing lines in distribution system 12. Thus, if the system 10 remains activated until all fire retardant is discharged through the nozzles, gas from pressure tank 52 will flush all plumbing lines of fire retardant.

Similarly, the activation switch 70 may be turned off in any of the ways described above at any time after activation. When the control system 16 deactivates the system 10 (i.e. turns switch 70 off), both valves 56 and 64 are closed. The activation switch may be turned off and then turned on again at a later time provided there is sufficient water and fire retardant in the double tank arrangement 50.

Control system 16 is capable of closing valves 56 and 64 at different times. For example, valve 56 may be closed before valve 64 so that the double tank arrangement 50 is allowed to depressurize for an interval of time. Valve 64 is then closed by control system 16. If deactivation is accomplished through use of various types of coded remote activation/access 76 (as previously described) before all water or fire retardant contained in double tank arrangement 50 has been discharged through system 10, the fire retardant mixture remaining the in the pipes 20 downstream of double tank arrangement 50 may be flushed out to clear the piping in the system to ready it for the next use. This is done by opening valves 56 and 67 with valve 64 closed. Valves 56 and 67 are allowed to remain open until all residual fire retardant has been discharged through the various nozzles.

In some embodiments, the fire retardant used in the system 10 is of the type that will remain on the surface onto which it has been sprayed, providing continuing protection against wildfire, until the residual retardant has been washed off.

It will be appreciated by those of ordinary skill in the art that certain modifications and additions may be made to the system 10 as described above and shown in the drawings. For example, the system may be designed to operate on a manual basis only, thereby omitting control system 16. In this case, only one manually operable valve may be used in place of valve 56 shown in the drawings and the system is activated by manually opening the valve to deliver gas from the pressure tank to the double tank arrangement 50. Also a hose having a nozzle on one end may be connected to the double tank arrangement 50 to allow mixed fire retardant to be manually sprayed on specific locations. Separate lines may be plumbed into the system similar to standard hose bibs that allow firefighters to connect external hoses to the actual fire retardant supply. As yet another modification, large “guns” of sprinkler heads such as impact heads may be mounted at tree-top level to provide greater coverage of the surrounding structures. Moreover, entire communities may be protected by a single, large-scale installation along the lines noted above. In this case, each structure in a community may be individually protected by a system 10, with a community perimeter system for delivering fire retardant to a line around the community may be used to great effect.

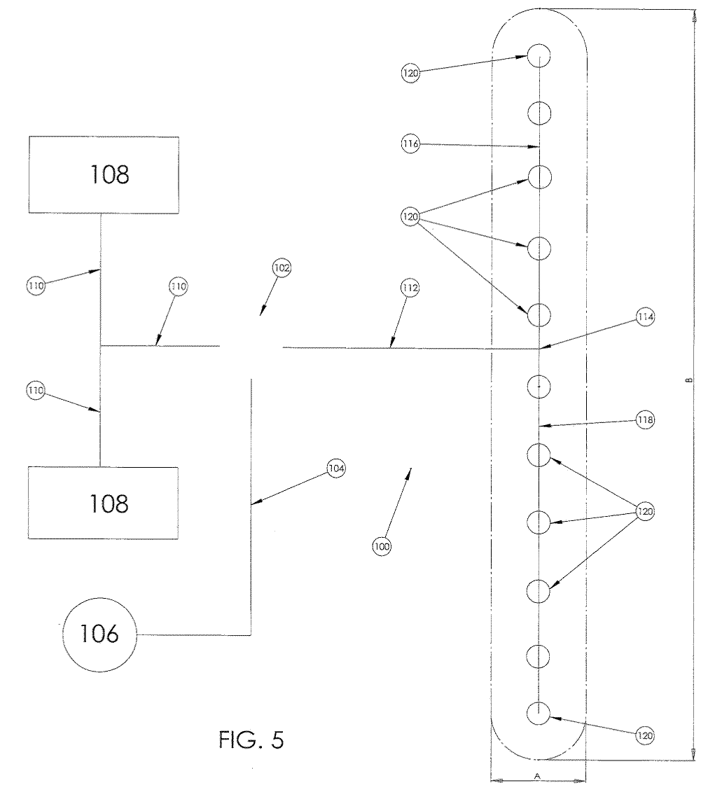

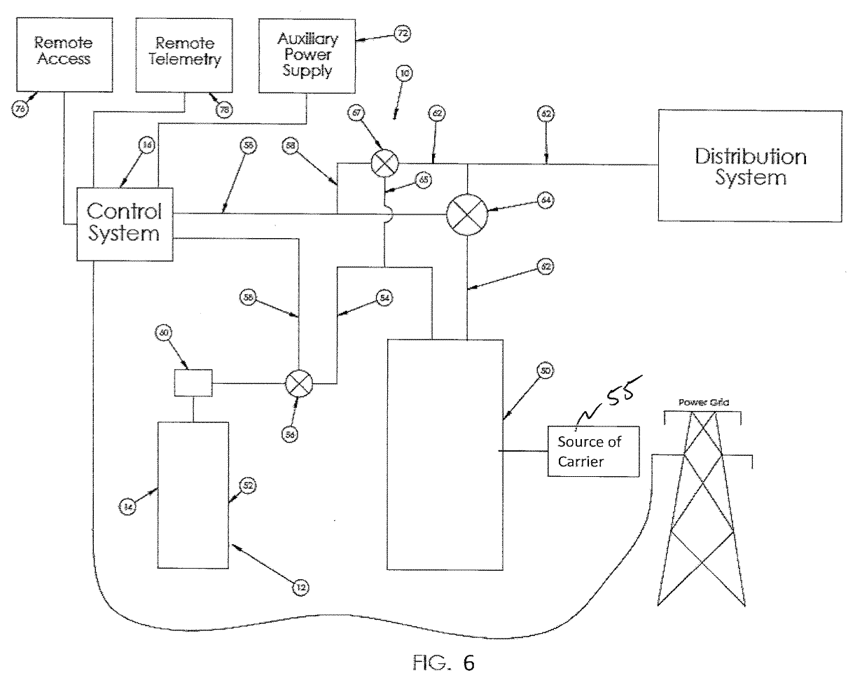

An additional embodiment is shown in FIG. 5. In this system 100, which is the type of system that is used to flank a fire to control fire direction or stop the fire's progress in a specific direction, a series of “big gun” distribution heads (such as those available from Nelson Irrigation Corporation, 848 Airport Road, Walla Walla, Wash. 99362-2271 USA) are positioned to spray fire retardant in a line over a relatively long distance. In many areas, historical fire data is available that provides a reliable statistical indicator of the direction that wildfires travel. In other words, in any given area, by relying upon factors such as weather, wind patterns, fuel distribution and historical fire data and/or historical fire patterns, firefighters are able to reliably predict wildfire direction and behavior. The system 100 is used to flank a fire by laying down a long line of fire retardant that is intended to stop a fire, or channel it away from a residential area, or toward an area where it is easier to fight, etc.

In some embodiments, system 100 relies upon a compressed gas powered pump 102 that is powered by compressed gas delivered to pump 102 through a line 104 that interconnects the pump to a tank 106 of a suitable compressed gas. Pump 102 may be a diaphragm-type pump such as the IR ARO™ diaphragm-type pumps available from Ingersoll-Rand Fluid Products (170/175 Lakeview Drive, Airside Business Park, Swords, Co. Dublin, Ireland), to name just one non-limiting example, and may be powered with compressed nitrogen or air in tank 106.

One or more reservoirs 108 consisting of multiple double tank arrangements 50 of both carrier or fire retardant are plumbed to pump 102 through pipes 110. These reservoirs 108 may be portable or located above ground, underground, or remotely from pump 102, as may the tank 106, depending upon the specific installation. A single outflow pipe 112 from pump 102 may be connected to a T-fitting 114 and there are two branch lines 116, 118 extending from the T-fitting. Plural spray distribution heads 120 are plumbed inline in the branch lines 116 and 118 —twelve distribution heads 120 are shown in the system 100 in FIG. 5.

Each distribution head 120 is preferably a “big gun” type of spray head configured to distribute a desired quantity of fire retardant. In the embodiment illustrated in FIG. 5, the system 100 is pressurized and the components are sized so that fire retardant is sprayed from each distribution head in a circle having a diameter of about 100 feet (dimension A in FIG. 5). It will be appreciated that the length of the perimeter line defined by branch lines 116 and 118 may be up to ¼ mile, and more, as shown by dimension B, FIG. 5. The area of ground onto which fire retardant is distributed with the system 100 is illustrated with dashed lines around the perimeter of the system.

Depending upon the area that is to be protected, several systems 100 may be arranged in series to provide a protection line that is many miles in length. The system 100 may beneficially be used to deliver fire retardant to at least a part of a perimeter around a residential area, and in particular those perimeter areas that are most prone to be hit by wildfire.

System 100 includes activation means for activating the system, which may be of any of the types described above.

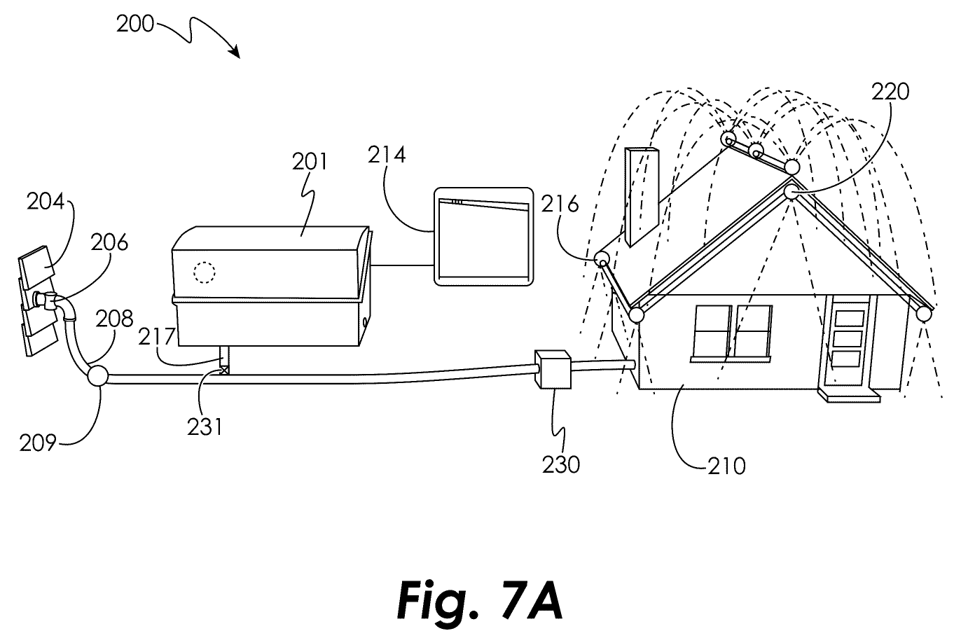

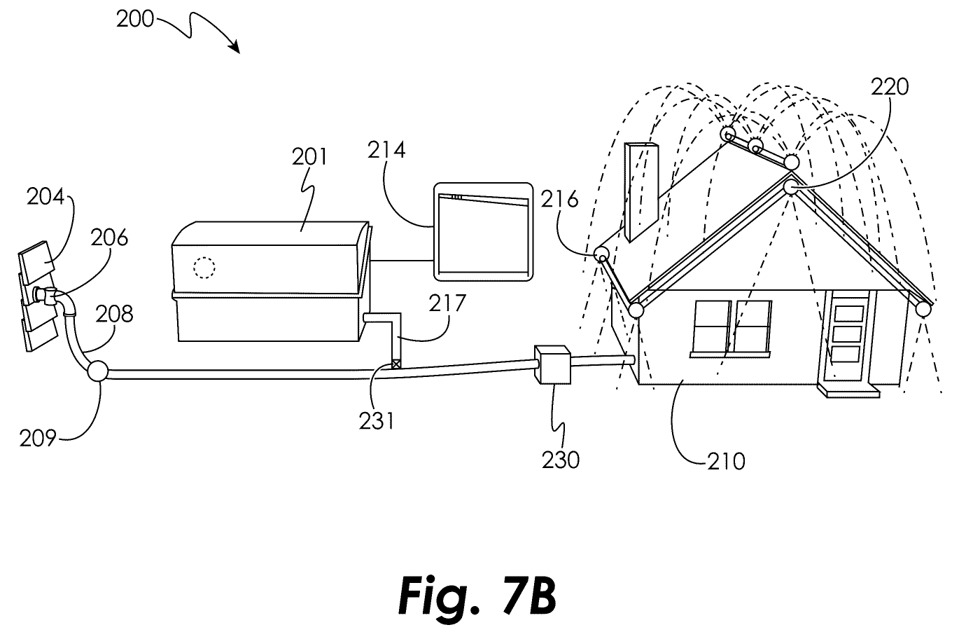

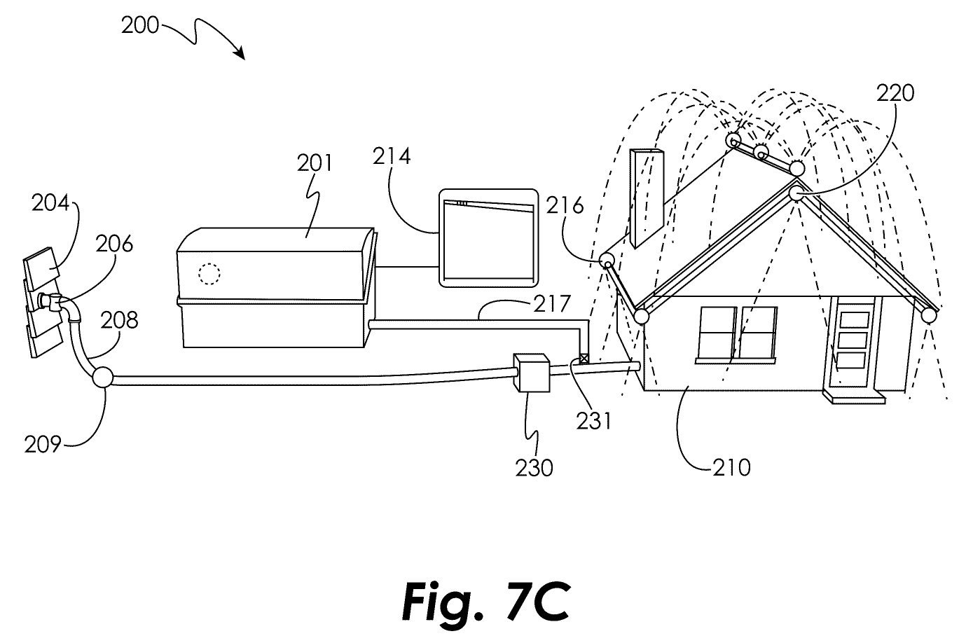

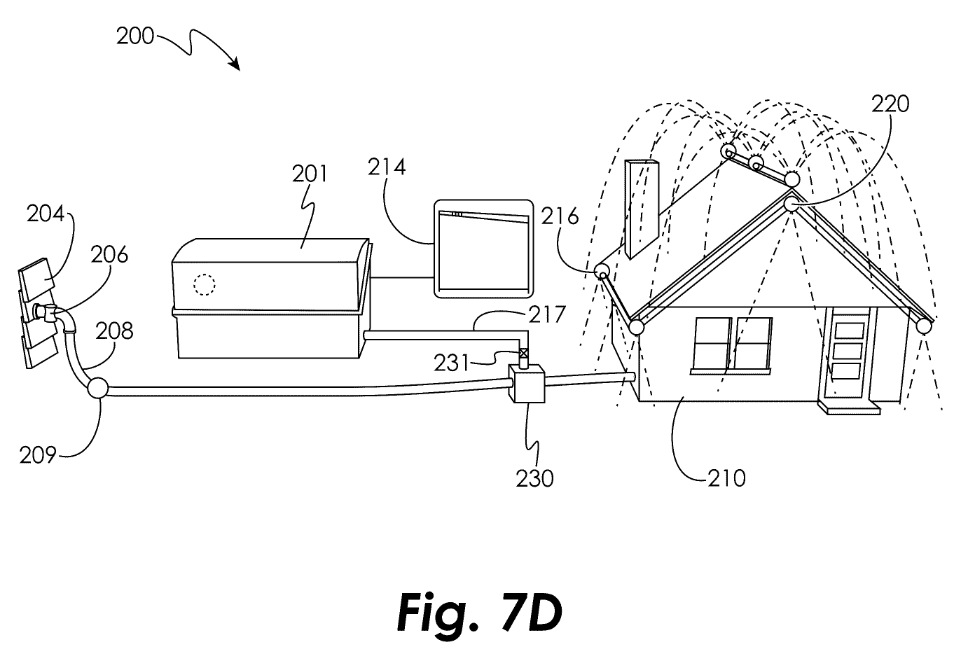

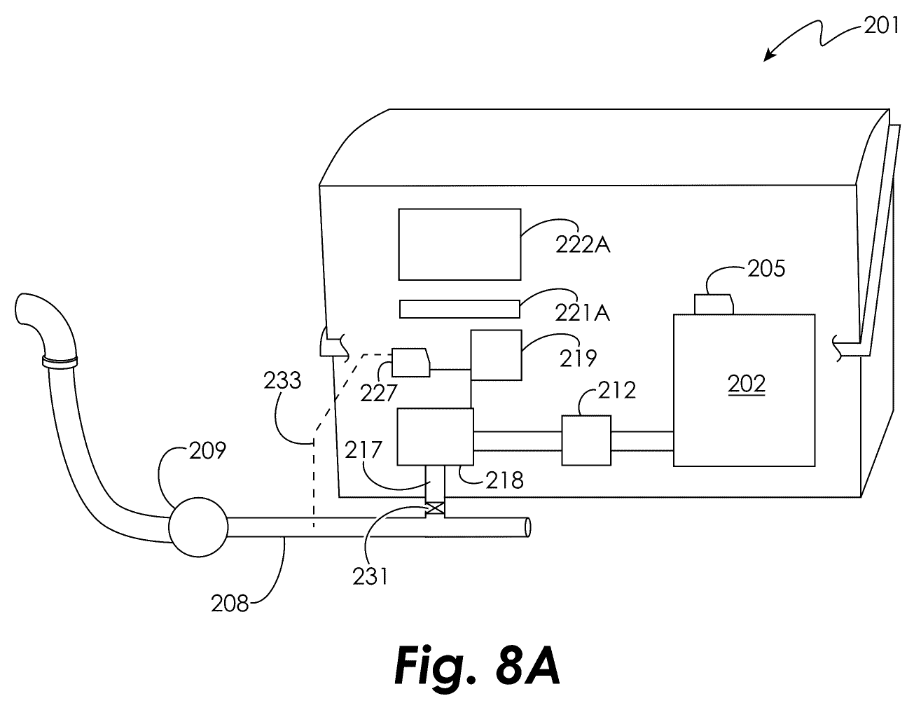

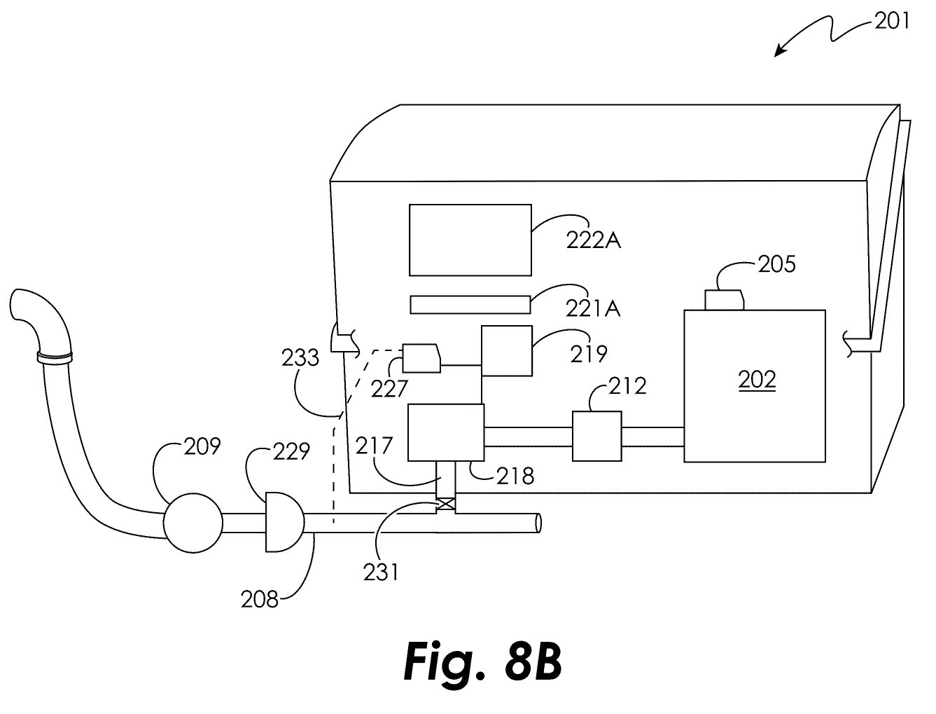

FIG. 7 illustrates one embodiment of a fire retardant delivery system 200 for protection from wildfire. The system 200 includes a containment module 201 (illustrated in detail in FIG. 8) for retaining at least some of the system components. In one embodiment, the containment module 201 is approximately 48 inches long, approximately 30 inches wide and approximately 30 inches tall and placed discreetly along the side of a structure 210 which is to be protected. In other embodiments, the containment module 201 may be any suitable size for the size of the structure 210. In other embodiments, the containment module 201 may be positioned anywhere within proximity to the structure 210. In some embodiments, more than one containment module 201 is included in system 200. In other embodiments, the containment module 201 is not included). As shown in FIG. 8, the containment module 201 includes a fire retardant tank 202. The retardant tank 202 contains a fire retardant. The containment module 201 further includes other equipment operative to apply the fire retardant. In one embodiment, the fire retardant is stored in a non-pressurized state. In one embodiment, the fire retardant is at least one of a liquid, a liquid foam concentrate, a gel, or a powder fire retardant. In one embodiment, the fire retardant is environmentally safe, non-toxic, and biodegradable. In one embodiment, the retardant tank 202 includes an agitator 205 to periodically stir the fire retardant.

The retardant tank 202 is in fluid communication with a source of carrier 204. The source of carrier 204 discharges a flow of carrier to mix with the fire retardant that is injected from the retardant tank 202 to create a fire retardant and carrier mixture. In one embodiment, the source of carrier 204 is selected from at least one of a water tank, a municipal water supply, a water well, a lake and/or a pond. In the illustrated embodiment, the source of carrier 204 is in fluid communication with the containment module 201 through a spigot 206 at the structure 210. Alternatively, the source of carrier 204 may be in fluid communication with the containment module 201 through the structure's water supply system. In the illustrated embodiment, a hose 208 fluidly couples the spigot 206 to the containment module 201. In other embodiments, any means for delivering a carrier, for example a pipe, may be utilized to fluidly couple the spigot 206 or the source of carrier 204 to the containment module 201. In one embodiment, an optional carrier valve (or set of valves) 209 may be positioned in fluid communication between the source of carrier 204 and an injection port 217 extending from the containment module 201. The carrier valve 209 is operative to either connect or disconnect the source of carrier 204 to the injection port 217. In one embodiment, a backflow protection valve (not shown) may be included to prevent backflow of carrier contaminated with retardant into the source of carrier 204. In the embodiment shown in FIG. 8B, a booster pump 229 is provided in flow communication with the hose 208 to increase a flow of the carrier.

Injection of the fire retardant into the carrier to form a fire retardant and carrier mixture is accomplished by a metering valve 218 (described in greater detail below). Fire retardant may be supplied from the retardant tank 202 to the metering valve 218 through a retardant valve (or set of valves) 212. In one embodiment, as illustrated in FIG. 8 the retardant valve 212 may be positioned within or adjacent to the retardant tank 202. A control system 214 may be operatively coupled to the retardant valve 212. In one embodiment, the control system 214 is coupled to a sensor 216, for example a heat sensor that detects the presence of fire. In one embodiment, upon detecting fire, the control system 214 is operative to open the retardant valve 212. When the retardant valve 212 is opened, the retardant flows through the metering valve 218 which injects the retardant into the hose 208 through the injection port 217. At least one check valve 231 prevents the flow of fire retardant and carrier mixture back into the containment module 201.

The metering valve 218 is constructed and arranged to meter a flow of the fire retardant into the carrier. The metering valve 218 may be positioned within the containment module 201 in one embodiment. In one embodiment, the metering valve 218 may be a direct current (DC) pump. In another embodiment, the metering valve 218 may be an alternating current (AC) pump. In one embodiment, the metering valve is a peristaltic pump. The metering valve 218 is configured to maintain a predetermined proportion of fire retardant to carrier in the fire retardant and carrier mixture. In one embodiment, the metering valve 218 meters the flow of retardant into the carrier based on an amount of carrier flowing from the carrier source 204. A flow meter 227 may be provided to measure the amount of carrier flowing from the carrier source 204. In particular, because the source of carrier 204 may not maintain the carrier at a uniform pressure, varying amounts of carrier may flow from the source of carrier 204 at different times. The metering valve 218 adjusts the amount of retardant being injected into the carrier to maintain a consistent proportion of fire retardant to carrier in the fire retardant and carrier mixture at a desired dilution rate. In one embodiment, the metering valve 218 is controlled by a metering valve control 219. The metering valve control 219 receives information from the flow meter 227 regarding the amount of carrier currently flowing from the carrier source 204 and uses this information to control a rate at which the metering valve 218 injects fire retardant into the carrier to form the fire retardant and carrier mixture. For example, in embodiments where the metering valve 218 is a pump, the metering valve control 219 slows the pump down when the flow meter 227 detects a reduction in the amount of carrier arriving from the source of carrier 204, and vice versa. The fire retardant is then injected into the hose 208.

At least one distribution nozzle 220 is positioned on or around the structure 210 and configured to deliver the fire retardant and carrier mixture to a desired area. In one embodiment, nozzles 220 are strategically mounted on the roof of the structure 210 and under the eaves of the structure 210 to facilitate evenly applying fire retardant and carrier mixture to all surfaces of the structure 210 including decks, windows and landscape. In one embodiment, the nozzles 220 are mounted to the structure 210 in a manner that keeps the nozzles 220 relatively unseen. In one embodiment, a valve box 230 controls a flow of at least one of fire retardant and carrier to the distribution nozzles 220. In one embodiment, shown in FIG. 7A, the fire retardant is injected into the carrier at the containment module 201, so that the valve box 230 controls the flow of the fire retardant and carrier mixture. In one embodiment, shown in FIG. 7B, the fire retardant is injected into the carrier downstream of the containment module 201 and upstream from the valve box 230, so that the valve box 230 controls the flow of the fire retardant and carrier mixture. In one embodiment, shown in FIG. 7C, the fire retardant is injected into the carrier downstream of the valve box 230, so that the valve box 230 controls the flow of only the carrier. In one embodiment, shown in FIG. 7D, the fire retardant is injected into the carrier at the valve box 230, so that the valve box 230 controls the flow of both the fire retardant and the carrier. In other embodiments, the fire retardant may be injected into the carrier at a location near the top of the structure and/or at the distribution nozzles 220.

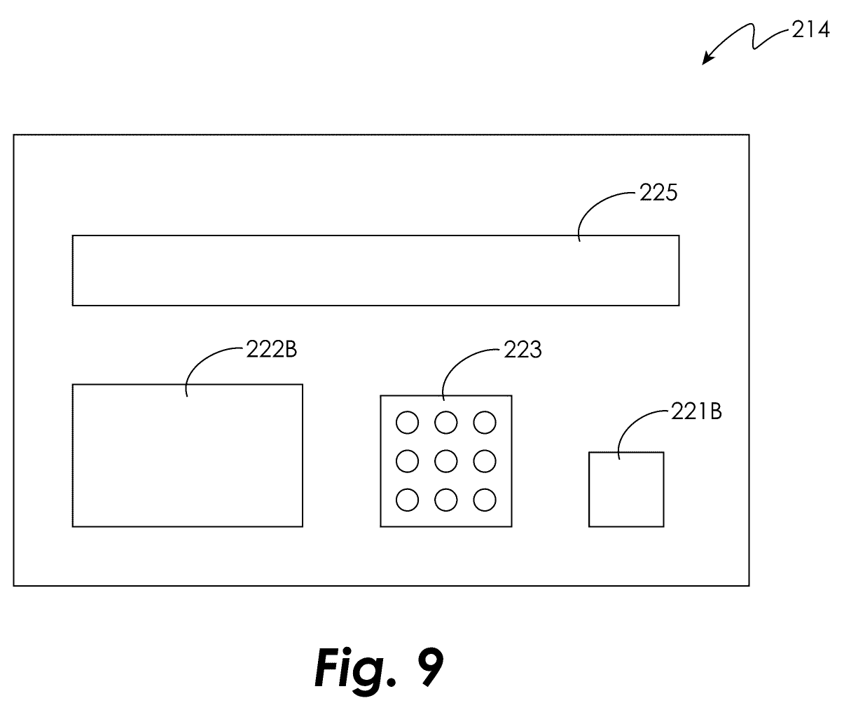

In one embodiment, the system 200 includes an autonomous power source 222, for example a battery, to power the system 200. In one embodiment, the power source 222 provides power to the system 200 so that the system 200 is able to operate in the event that there is no electrical transmission to the property. In one embodiment, the control system 214 and the overall system 200 may be controlled by separate autonomous power sources. In one embodiment, a single backup power source powers both the system 200 and the control system 214. In one embodiment, at least one autonomous power source 222A is positioned within of the containment module 201, as illustrated in FIG. 8. In one embodiment, at least one autonomous power source 222B is positioned in the control system 214, as illustrated in FIG. 9. In other embodiments, the system requires no separate power source 222, and power is supplied to the system by the water pressure supplied by municipal water lines or a well-based water system. In such embodiments, the valve box 230 (e.g., a proportioning valve or proportioner) requires no external power, as it operates by the pressure of the water coming into the proportioner. The proportioner is able to adjust the amount of foam concentrate or other fire retardant being proportioned into a variable water stream.

In one embodiment, the system 200 can be activated through a cell phone, through a smart phone app, through telephonic code, through computer log in, and/or through the direct push of a button, to name just a few non-limiting examples. In one embodiment, the system 200 allows for remote activation by a home security or home automation system. In one embodiment, the control system 214 enables two way communications between the system 200 and at least one of the devices listed above. In one embodiment, a modem 221 or other communication device enables the two way communications. As illustrated in FIG. 8, the containment module 201 may include at least one modem 221A and at least one autonomous power source 222A. The control system 214 is further illustrated in FIG. 9. As illustrated in FIG. 9, at least one modem 221B and at least one autonomous power source 222B may be provided within the control system 214. Additionally, a keypad 223 and connectors 225 for zone valves (described in more detail below) may also be positioned within the control system 214. In one embodiment, the connectors 225 may be housed in another enclosure that is separate from the control system 214. In one embodiment, the system 200 is coupled to a burglar alarm to notify authorities of the presence of fire.

In one embodiment, after the fire retardant is applied to the structure 210, the fire retardant can be rehydrated multiple times during a wildfire event and remains effective in protecting the structure for predetermined period of time depending on ambient environmental conditions. After applied, the fire retardant may be cleaned up through the use of a hose, a power washer, and/or any other device capable of spraying water.

In one embodiment, during operation, the system 200 may be plumbed into the structure's water supply system as the source of carrier 204. In one embodiment, the carrier fills the system 200 up to the valve box 230, when the system is inactive. In particular, water travels down the hose 208 to the valve box 230 via the force of the city water or rural well pump. When the system 200 is inactive, the carrier in the system 200 is not mixed with retardant. Upon activation of the system 200, the valve box 230 opens the output line 217 to the distribution nozzles 220, and the carrier within the system 200 that is not mixed with retardant flows through the distribution nozzles 220 to run water through at least one zone onto the structure 210. New water entering the system 200 is injected with fire retardant from the retardant valve 212 to proportionally inject the fire retardant into the water stream at a pre-set dilution rate. This proportioning system may be capable of accommodating spikes and dips in the rate of carrier flow, as measured by the flow meter 227, so that fire retardant is injected into the carrier at the desired dilution rate. After being injected the fire retardant and carrier mixture is applied to the structure 210 or landscape. The structure 210 may have multiple zones and the fire retardant and carrier mixture is applied via these zones. In one embodiment, the fire retardant and carrier mixture is applied one zone at a time. In other embodiments, the fire retardant and carrier mixture may be applied to multiple zones at the same time. The fire retardant and carrier mixture may be applied through sprinkler heads, the types of which will vary based on zone location, but may include irrigation rotors, spray heads, and micro irrigation mister type heads, to name just a few non-limiting examples. All surfaces on the structure 210 are treated with fire retardant and carrier mixture including the roof, walls, glass, eaves, and decks. Also treated is an area of the landscape surrounding the structure 210. In one embodiment, the fire retardant may be rehydrated multiple times. In another embodiment, only the roof and surrounding landscape is treated.

One or more devices, systems, and/or methods may include one or more hydraulic management techniques. One or more hydraulic management techniques may include monitoring and/or adjusting a hydraulic capacity of the water supply at an individual structure 210 and/or within an area, for example. One or more, or each, fire monitoring/suppression systems may have a flow meter and/or a water pressure sensing device installed at the point of connection to the water supply and/or downstream therefrom. Perhaps, for example, when a monitoring/suppression system demand exceeds the hydraulic capacity of the water supply, among other reasons, such a monitoring/suppression system may adjust the flow of the fire retardant and/or carrier mixture to higher risk areas on the structure 210 (e.g., roof surfaces), and/or to higher risk areas within an active wildfire region. The one or more hydraulic management techniques may be applied to one or more, or multiple, houses/structures/buildings and/or one or more, or multiple areas (e.g., not limited to an individual house/structure/building and/or area). One or more hydraulic management techniques may manage the hydraulic capacity within an entire region of wildfire activity, for example.

For example, one or more hydraulic management techniques may curtail flow of the fire retardant and/or carrier mixture to certain surface areas which are less susceptible to fire embers (e.g. vertical walls) and/or may direct flow of the fire retardant and/or carrier mixture to continue and/or increase on higher risk horizontal surfaces (e.g. roofs and/or decks). As used herein, the term “horizontal” may include surfaces that are completely horizontal, and/or surfaces which might not be completely horizontal (e.g., which may have a non-vertical slope, such as sloped roofs, etc., and the like).

For example, on a regional basis (e.g., an active fire region), perhaps if twenty systems are operating, perhaps at least fifteen systems may be treating horizontal surfaces (e.g., high-risk surfaces), while perhaps five systems (e.g., one or more of which may be the same systems as the fifteen systems and/or one or more of which may be different systems than the fifteen systems) may be treating vertical surfaces (e.g., lower-risk surfaces). There might not be sufficient flow and/or pressure to operate most of, or all of, the twenty systems completely. One or more hydraulic management techniques may throttle flow (e.g., reduce flow, perhaps even to substantially zero flow) of the fire retardant and/or carrier mixture to one or more, or all, of the vertical surfaces, which may preserve and/or increase flow to one or more, or all, of the horizontal surfaces. One or more hydraulic management techniques may increase and/or maintain the flow of water and/or fire retardant to areas/fire suppression systems that are closer to the perimeter of the wildfire area (e.g., an active fire region) and/or may reduce the flow of water and/or fire retardant to areas/fire suppression systems that may be further away from the perimeter of the wildfire area. In one embodiment, a fire department may create a polygon on a map displayed on an input screen of a control system operative to control a plurality of the presently disclosed systems, and execute a command that activates all systems located within the area contained within the polygon, and such systems would then be subject to the hierarchy of hydraulic management disclosed herein.

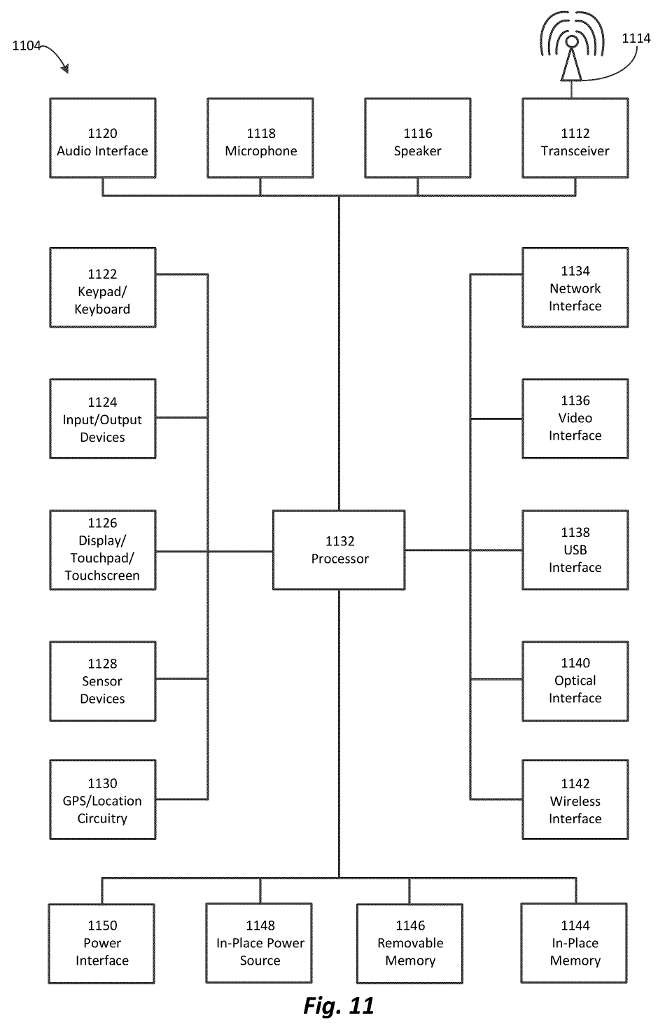

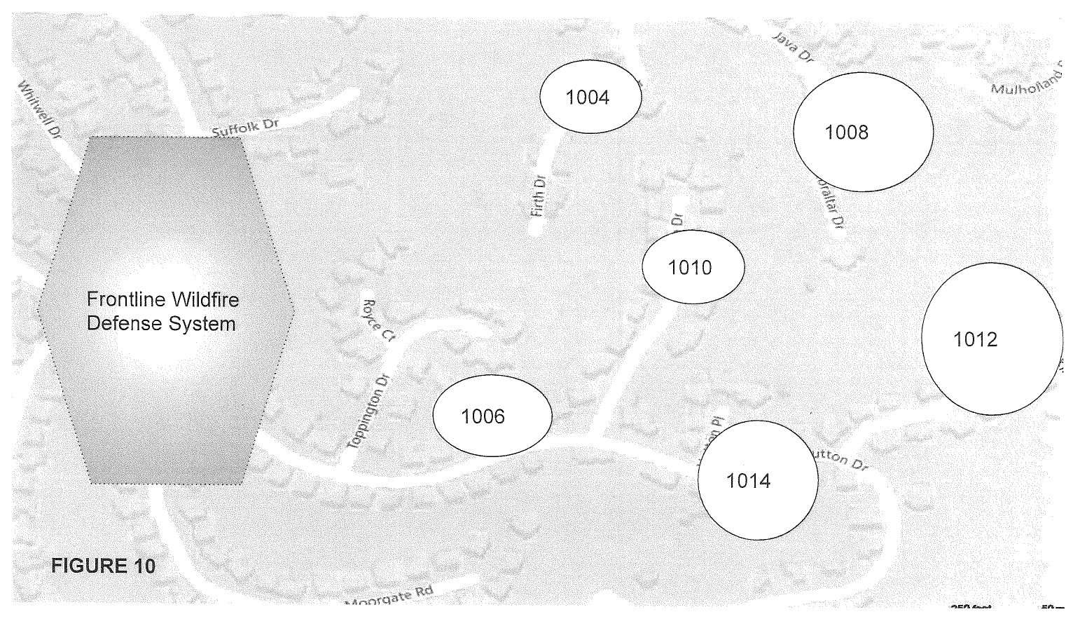

Devices, systems, and/or methods that may protect buildings from wildfire and/or other fire hazards may be useful. Devices, systems, and/or methods that not only protect a building from wildfire and/or other fire hazards, but also creates a “protection effect” on one or more surrounding buildings may be useful. For example, an incident command system, such as (or including) one of the control systems disclosed herein, may be used by a fire service to initiate an immediate georeferenced event at the location of an incident. If the incident is a structure fire (interior or exterior), for example, this would cause the control system to automatically activate fire suppression systems on either side of the structure that is burning. By doing so, adjacent structures would be immediately cooled and thereby not reach a combustion point. In another example, by having a network of fire suppression systems under the control of a control system as disclosed herein, a mesh is created where when one fire suppression system activates, other fire suppression systems under the control of the control system are thereby activated according to predetermined rules contained in the control system. FIG. 11 and the accompanying description below provides additional details for such a control system.

Devices, systems, and/or methods that implement one or more algorithms that: may identify one or more geographical areas that possess (e.g., varying) degrees of wildfire exposure, that may identify one or more hazard/exposure radius from a wildfire to the public, and/or that may identify one or more areas that are more protected from wildfire than others may be useful. For example, state and/or federal governments can use the output of such one or more algorithms to establish an accurate radius from a wildfire to be used for public health and/or safety. Also by way of example, insurance companies can use the output of such one or more algorithms for determination of portfolio risk exposure and/or risk reduction.

One or more algorithms may rank fire hazard rating(s) of one or more (e.g., individual) buildings and/or areas (e.g., of different sizes), perhaps with significantly higher accuracy than conventional tools. The output of the one or more ranking algorithms (and/or the algorithms themselves) may be useful for insurance companies, federal government(s), state/local governments, municipalities, fire districts, realtors, companies that provide fire hazard ranking systems, and/or companies that offer wildfire mitigation services.

For example, insurance companies can use the output of the one or more algorithms to (e.g., better) set insurance prices, and/or to reduce operational costs associated with the identification of risk. For example, federal government(s), state/local governments, fire districts, and/or municipalities can use the output of the one or more algorithms to determine (e.g., more accurate) evacuation trigger points for purposes of maintaining public health and/or safety. One or more private firefighting agencies can use the output of the one or more algorithms to identify potential customers in wildfire exposure areas. The output of the one or more algorithms may be used by public/private agencies for other natural disaster scenario analysis, perhaps in addition to fire analysis.

Currently, insurance companies and/or vendors to the insurance industry, perhaps among others, may use geo-information and/or weighting algorithms to assess fire risk. The accuracy of currently used techniques is questionable. Many currently used techniques operate without knowledge of their respective accuracies. Currently used techniques might not use historical information to identify if their algorithms are accurate. As such, currently used techniques might not possess any feedback loop for purposes of retooling/adjusting the respective algorithms. For example, currently used techniques often find that burned/burnt-down houses were marked safe. Currently used techniques should not have marked those houses as safe, and should have been aware (e.g., via feedback loop(s)) that those houses were already burned/burnt-down.

One or more algorithms disclosed herein may create higher levels of accuracy in determining areas of exposure. One or more algorithms disclosed herein may include one or more feedback loops to verify algorithm accuracy and/or to automatically retool/adjust algorithm accuracy.

One or more algorithms disclosed herein may consume one or more currently available fire risk rankings. The one or more algorithms may incorporate such rankings into the algorithm(s), and/or may add one or more factors, which may make the one or more algorithms (e.g., significantly) more accurate than existing and/or previous methods.

The one or more algorithms may include one or more, or multiple feedback loops. The one or more feedback loops may include review, analysis, and refinement of the algorithm after one or more, or each, fire. Information and/or data provided from the one or more feedback loops may be included in the (e.g., dynamic) evolution of the one or more algorithms. Ranking(s) produced by at least some of the one or more algorithms may be improved by using image processing of maps, for example.

One or more algorithms may include the effect of ember hazard(s) and/or may use simulated scenarios to identify the reaction to such events on a building(s) and/or its surroundings.

One or more algorithms may implement one or more public safety mechanisms to identify one or more geographic locations or points from which an evacuation process(es), or shelter in place process, may be activated by the fire service or by federal, state, and/or local government officials. The one or more public safety mechanisms may assist in the identification of fire control and monitoring systems, and/or such systems' risk mitigating effect on civilian and/or first responder life and safety, and/or the risk mitigation effects on nearby buildings. By using information/data provided by the one or more feedback loops, the one or more algorithms may continuously and/or dynamically evolve.

One or more algorithms may include at least one module that (e.g., automatically) identifies fire incidents. For example, fire incidents may be identified by collecting information/data through (e.g., established) structured data sources and/or unstructured Internet public data, perhaps for example including personal data of people affected by fire(s) in social media. Such information may be used (e.g., perhaps with artificial intelligence) to establish one or more machine learning loops.

For example, the georeferenced location of fire perimeters may be defined in maps available to the control system. Often, however, structures burn outside of these fire perimeters due to win-borne embers landing on adjacent structures. The control system may also have access to data (such as, for example, local, state, and/or federal government data) that identifies and logs the georeferenced location of structures burned in a fire. By overlaying the location of the fire perimeter on top of the location of where structures burned, the control system obtains a true representation of the ember effect of wildfires. In some cases, these embers can land five miles outside of the fire perimeter. This is an analysis that is helpful to understand what structures are exposed to fire damage if there is a fire.

As another example, the control system algorithm may compare two sets of data, such as georeferenced fire perimeter data and population data for example, and determine a correlation between population and the occurrence of fire incidents. The control system would thus learn where fire is more likely to start based on population within a monitored area.

As a further example, the control system algorithm may perform a suppression analysis based on available infrastructure, such as the number and size of roadways providing access to an area to actually reach a fire with human personnel, and/or availability of aircraft/vehicles operative to suppress a fire, and determine a correlation between the success of suppression efforts based on access to such infrastructure. Such data may be further correlated to other variables, such as time of year, or past, present or predicted future weather event in the area.

As another example, the control system algorithm may perform analysis on historical data of square footage/acres of combustible material (i.e., critical fire mass) to determine the probability of a fire if the area is not suppressed at a certain time of year (based on historical weather patterns), which allows a prediction of the size of civilian population and structure population that is threatened by fire.

By providing a control system algorithm capable of such analysis, in some embodiments as part of a search query mechanism, and operating on top of a self-learning algorithm, the system may provide predictability of exposure to civilian populations, homes, and infrastructure to fire.

In one or more techniques, computing device 1104 and/or control system 214 may be configured to determine one or more activation triggers for any of the fire suppression systems described herein. The computing device 1104 and/or control system 214 may perform a reconfiguration of the computing device 1104 and/or control system 214, perhaps for example using the information and/or data. In one or more techniques the computing device 1104 and/or control system 214 may be configured to determine one or more adjusted activation triggers, perhaps based on the reconfiguration.

Also by way of example, the at least one module may identify one or more houses/structures/buildings that were in a fire's range and/or were in danger of fire damage/destruction and were saved or not burned (e.g., for known or unknown reasons). Such houses/structures/buildings may be marked and/or alerted with a notification of some kind (e.g., a “you were lucky” alert or notification, and/or the like). Such alerts and/or notifications may be transmitted via a communication (e.g., email, government mail, private courier, text message, and/or telephone call, and/or the like). The alerts and/or notifications may advise owners/renters/lessees, etc., of such houses/structures/buildings that their properties were in hazards' way and, for whatever reason, their properties were not damaged (e.g., a “you got lucky this time” warning, and/or the like). The alerts and/or notifications may urge and/or motivate the owners/renters/lessees, etc., to protect themselves from future hazards which could result in damage/destruction of their properties and/or harm to their person. The messaging of wildfire exposure is a core component to creating a safer civilian environment.

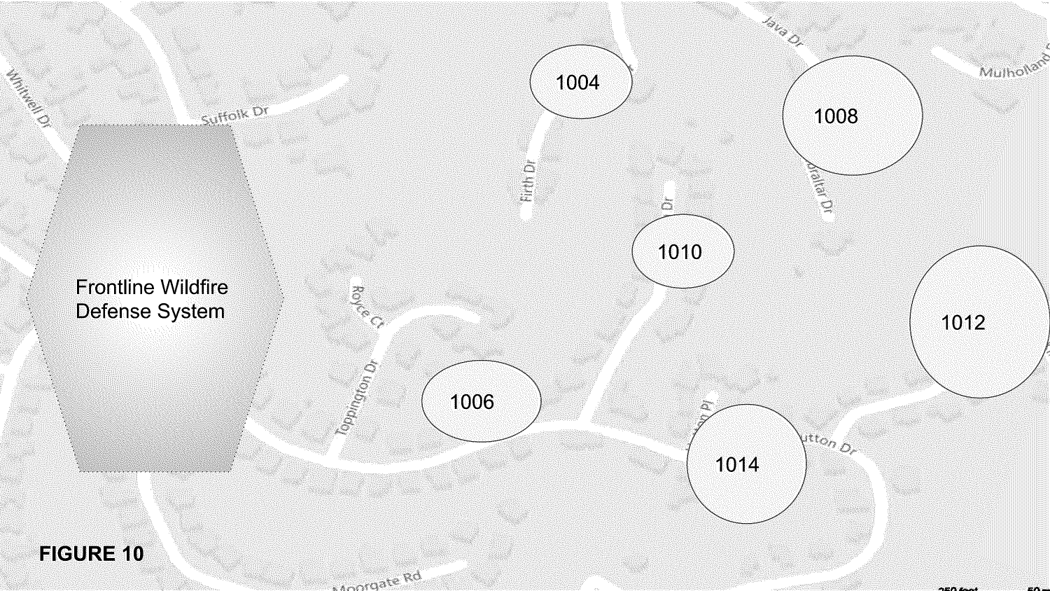

FIG. 10 includes an example topography illustration indicating an assessment of fire-hazard zones. In FIG. 10, zones 1002-1014 of potential fire hazard are illustrated. If a single structure is burning when there is no wildfire, there are firefighting resources to protect the structure. When a single structure is burning during a wildfire, or a plurality of structures is burning during a wildfire, the exposure is simply so great that it overwhelms traditional firefighting resources and capabilities. The presently disclosed embodiments provide automated systems to mitigate such limitations of traditional firefighting resources.

The potential fire hazard among at least some of the zones 1002-1014 may be the same or substantially similar, and/or the potential fire hazard among at least some of the zones 1002-1014 may be different or significantly different. For example, zone 1002 may have an 85% rank of fire potential, zone 1004 may have an 85% rank of fire potential, zone 1006 may have a 50% rank of fire potential, zone 1008 may have a 42% rank of fire potential, zone 1010 may have a 94% rank of fire potential, zone 1012 may have an 88% rank of fire potential, and/or zone 1014 may have a 60% rank of fire potential (a 0-100% scale describing a rank of fire potential being used by way of example, and not limitation).

One or more techniques of estimating risk of exposure to fire for one or more regions of a geographic territory may include determining a first fire risk rank for at least one region of the one or more regions, perhaps for example based on one or more current atmospheric conditions corresponding to the at least one region. One or more techniques may include determining one or more fire characteristics of the at least one region. Perhaps, for example, there has been a historical pattern of fire that occurs approximately every 80 years in a similar general location either within an area identified in FIG. 10, or within a 5 mile radius of the area identified within FIG. 10. As an additional consideration to this analysis, perhaps the general civilian population and amount of infrastructure in the area identified within FIG. 10 was below current levels in that area 80 years before. This is one limited example of a fire characteristic evolving and creating a differing level of exposure. Perhaps, for example, based at least on one image of the at least one region, it is known that the composition of structures (residential and commercial) are of a density and arrangement that when a plurality of such structures are exposed to an ember effect from a wildfire burning within a 5 mile radius of the area that, given the firefighting resources available, the amount of exposure exceeds the capabilities of the firefighting resources.

One or more techniques may include determining a number of fire suppression systems located in or near the at least one region, which may provide additional firefighting capabilities and thereby reduce the potential for structure(s) loss. One or more techniques may include determining one or more ember hazard effects for the at least one region based on at least one image captured after a (e.g., temporally) recent past fire in or near the at least one region. For example, the image may comprise a map image of a fire perimeter from a recent past fire. Perhaps many of the structures outside of these fire perimeters were also burned. Local, state, and/or federal government data identifies and georeferences where structures burned in a fire. By overlaying the location of the fire perimeter on top of the location of where structures burned, a true representation of the ember effect of wildfires is created, and it is determined that burning embers landed five miles outside of the fire perimeter, threatening a population and quantity of structures that is far in excess of those contained within the fire perimeter. Correlating the size of the fire to the distance of ember travel and the subsequent exposure of civilian populations and structures based on the density and arrangement of those homes further define the true exposure of wildfire.

As a further example, analysis of the data usually reveals a correlation between population and the occurrence of fire incidents. This is a valuable analysis of where fire is likely to start based on population and historical fire events.

One can further analyze the success of fire suppression efforts based on available infrastructure to actually reach a fire with human personnel, or manmade aircraft/vehicles to suppress a fire, and see a correlation between the success of fire suppression efforts based on access. The data may also be analyzed for correlations based on time of year, or weather events.

As another example, further analysis based on historical data of square footage/acres of combustible material (i.e., critical fire mass) to determine the probability of a fire if the area is not suppressed at a certain time of year (based on historical weather patterns), which allows a prediction of the size of civilian population and structure population that is threatened by fire.

By performing such analysis, in some embodiments as part of a search query mechanism, and operating on top of a self-learning algorithm, there will be increased predictability of exposure to civilian populations, homes, and infrastructure, and devices, systems, and/or methods can be controlled to create civilian safety and protection, inclusive of infrastructure.

One or more techniques may include adjusting the first fire risk rank to a second fire risk rank, perhaps for example based on one or more of the number of fire suppression systems, the one or more ember hazard effects, and/or the one or more fire characteristics. One or more techniques may include determining an evacuation condition based on the second fire risk rank. One or more techniques may include communicating the evacuation condition to one or more recipients. The evacuation condition may include determining a second fire risk rank evacuation trigger threshold.

One or more techniques may include determining a recently extinguished fire impact on at least one structure in or near the at least one region. One or more techniques may include performing a comparison of the recently extinguished fire impact on the at least one structure with the second fire risk rank. One or more techniques may include determining a predicted hazard assessment for the at least one structure based on the comparison. For example, little-to-no fire damage to a structure in or near a region with a high fire risk rank may result in a “low” or “abnormal” predicted hazard assessment (e.g., an assessment that despite a relatively high fire risk rank, the structure received little-to-no actual/confirmed fire damage). For example, significant-to-total damage to a structure in or near a region with a high fire risk rank may result in a “high” or “expected” predicted hazard assessment (e.g., an assessment that with a relatively high fire risk rank, the structure received significant fire damage, if not a complete loss). Stated somewhat differently, a predicted hazard assessment may be a measurement, an evaluation, and/or a comparison of a fire risk rank (e.g., for a structure and/or a region) to actual/confirmed fire damage (e.g. to the structure and/or the region).

Again by way of example, if a first region that had a relatively low fire risk rank experienced little-to-no fire damage, then the predicted hazard assessment for a recent fire in or near the first region might be one or more of “high”, “expected”, “acceptable”, and/or “normal”, and/or the like. Also by way of example, if a first structure had a relatively low fire risk rank and experienced significant-to-total damage, then the predicted hazard assessment for a recent fire in and/or near the first structure might be one or more of “low”, “unexpected”, “unacceptable”, and/or “abnormal”, and/or the like. One or more techniques may include communicating the predicted hazard assessment for the at least one structure and/or region to an owner of the at least one structure, and/or to owners of one or more structures in the region, for example.

One or more techniques may include determining one or more indicators of a current fire in or near the at least one region from an internet-based social media system. For example, fires can move at such a rapid rate of spread that satellite imagery or infrared imagery can be too slow to keep up with identifying where fire perimeters are located, or where spotting occurs and new spot fires are burning. Various social media platforms, such as Twitter® to name one non-limiting example, are places where fire information is rapidly shared by individuals. An algorithm may analyze such social media posts for references to fire and quickly compile a georeferenced map of reported fires. Additionally, a mobile device application may be distributed to the general public that will allow a user to easily report a fire using the application, perhaps with the application automatically georeferencing the reported fire using the GPS location of the mobile device. One or more techniques may include adjusting the second fire risk rank based on the one or more indicators.

FIG. 11 is a diagram of an example computer (e.g., processing) device 1104 (which may be incorporated near and/or within the control system 16 and/or near and/or within the remote activation/access 76) wherein one or more of the devices, methods, and/or systems disclosed herein may be implemented, at least in part. In FIG. 11, the computer device 1104 may include one or more of: a processor 1132, a transceiver 1112, a transmit/receive element (e.g., antenna) 1114, a speaker 1116, a microphone 1118, an audio interface (e.g., earphone interface and/or audio cable receptacle) 1120, a keypad/keyboard 1122, one or more input/output devices 1124, a display/touchpad/touch screen 1126, one or more sensor devices 1128, Global Positioning System (GPS)/location circuitry 1130, a network interface 1134, a video interface 1136, a Universal Serial Bus (USB) Interface 1138, an optical interface 1140, a wireless interface 1142, in-place (e.g., non-removable) memory 1144, removable memory 1146, an in-place (e.g., removable or non-removable) power source 1148, and/or a power interface 1150 (e.g., power/data cable receptacle). The computing device 1104 may include one or more, or any sub-combination, of the aforementioned elements.

The computing device 1104 may take the form of a laptop computer, a desktop computer, one or more circuit boards, a computer mainframe, a server, a terminal, a tablet, a smartphone, and/or a cloud-based computing device (e.g., at least partially), and/or the like.

The processor 1132 may be a general-purpose processor, a special-purpose processor, a conventional processor, a digital-signal processor (DSP), a plurality of microprocessors, one or more microprocessors in association with a DSP core, a controller, a microcontroller, one or more Application Specific Integrated Circuits (ASICs), one or more Field Programmable Gate Array (FPGAs) circuits, any other type of integrated circuit (IC), and/or a finite-state machine, and/or the like. The processor 1132 may perform signal coding, data processing, power control, sensor control, interface control, video control, audio control, input/output processing, and/or any other functionality that enables the computing device 1104 to serve as and/or perform as (e.g., at least partially) one or more of the devices, methods, and/or systems disclosed herein.

The processor 1132 may be connected to the transceiver 1112, which may be connected to the transmit/receive element 1124. The processor 1132 and the transceiver 1112 may operate as connected separate components (as shown). The processor 1132 and the transceiver 1112 may be integrated together in an electronic package or chip (not shown).

The transmit/receive element 1114 may be configured to transmit signals to, and/or receive signals from, one or more wireless transmit/receive sources (not shown). For example, the transmit/receive element 1114 may be an antenna configured to transmit and/or receive RF signals, cellular signals, or satellite signals. The transmit/receive element 1114 may be an emitter/detector configured to transmit and/or receive IR, UV, or visible light signals, for example. The transmit/receive element 1114 may be configured to transmit and/or receive RF and/or light signals. The transmit/receive element 1114 may be configured to transmit and/or receive any combination of wireless signals.

Although the transmit/receive element 1114 is shown as a single element, the computing device 1104 may include any number of transmit/receive elements 1114 (e.g., the same as for any of the elements 1112-1150). The computing device 1104 may employ Multiple-Input and Multiple-Output (MIMO) technology. For example, the computing device 1104 may include two or more transmit/receive elements 1114 for transmitting and/or receiving wireless signals.

The transceiver 1112 may be configured to modulate the signals that are to be transmitted by the transmit/receive element 1114 and/or to demodulate the signals that are received by the transmit/receive element 1114. The transceiver 1112 may include multiple transceivers for enabling the computing device 1104 to communicate via one or more, or multiple, radio access technologies, such as Universal Terrestrial Radio Access (UTRA), Evolved UTRA (E-UTRA), and/or IEEE 802.11, and/or satellite, for example.

The processor 1132 may be connected to, may receive user input data from, and/or may send (e.g., as output) user data to: the speaker 1116, microphone 1118, the keypad/keyboard 1122, and/or the display/touchpad/touchscreen 1126 (e.g., a liquid crystal display (LCD) display unit or organic light-emitting diode (OLED) display unit, among others). The processor 1132 may retrieve information/data from and/or store information/data in, any type of suitable memory, such as the in-place memory 1144 and/or the removable memory 1146. The in-place memory 1144 may include random-access memory (RAM), read-only memory (ROM), a register, cache memory, semiconductor memory devices, and/or a hard disk, and/or any other type of memory storage device.

The removable memory 1146 may include a subscriber identity module (SIM) card, a portable hard drive, a memory stick, and/or a secure digital (SD) memory card, and/or the like. The processor 1132 may retrieve information/data from, and/or store information/data in, memory that might not be physically located on the computing device 1104, such as on a server, the cloud, and/or a home computer (not shown).

One or more of the elements 1112-1146 may receive power from the in-place power source 1148. In-place power source 1148 may be configured to distribute and/or control the power to one or more of the elements 1112-1146 of the computing device 1104. The in-place power source 1148 may be any suitable device for powering the computing device 1104. For example, the in-place power source 1148 may include one or more dry cell batteries (e.g., nickel-cadmium (NiCd), nickel-zinc (NiZn), nickel metal hydride (NiMH), lithium-ion (Li-ion), etc.), solar cells, and/or fuel cells, and/or the like.

Power interface 1150 may include a receptacle and/or a power adapter (e.g., transformer, regulator, and/or rectifier) that may receive externally sourced power via one or more AC and/or DC power cables, and/or via wireless power transmission. Any power received via power interface 1150 may energize one or more of the elements 1112-1146 of computing device 1104, perhaps for example exclusively or in parallel with in-place power source 1148. Any power received via power interface 1150 may be used to charge in-place power source 1148, such as a solar panel, a water micro-turbine, a micro wind turbine, a battery pack, or a generator.

The processor 1132 may be connected to the GPS/location circuitry 1130, which may be configured to provide location information (e.g., longitude and/or latitude) regarding the current location of the computing device 1104. The computing device 1104 may acquire location information by way of any suitable location-determination technique.

The processor 1132 may be connected to the one or more input/output devices 1124, which may include one or more software and/or hardware modules that provide additional features, functionality and/or wired and/or wireless connectivity. For example, the one or more input/output devices 1124 may include a digital camera (e.g., for photographs and/or video), a hands free headset, a digital music player, a media player, a frequency modulated (FM) radio unit, an Internet browser, and/or a video game player module, and/or the like.

The processor 1132 may be connected to the one or more sensor devices 1128, which may include one or more software and/or hardware modules that provide additional features, functionality and/or wired and/or wireless connectivity. For example, the one or more sensor devices 1128 may include an accelerometer, an e-compass, a vibration device, a sonar, and/or the like.

The processor 1132 may be connected to the network interface 1134, which may include one or more software and/or hardware modules that provide additional features, functionality and/or wireless and/or wired connectivity. For example, the network interface 1134 may include a Network Interface Controller (NIC) module, a Local Area Network (LAN) module, an Ethernet module, a Physical Network Interface (PNI) module, and/or an IEEE 802 module, and/or the like.

The processor 1132 may be connected to the video interface 1136, which may include one or more software and/or hardware modules that provide additional features, functionality and/or wired and/or wireless connectivity. For example, the video interface 1136 may include a High-Definition Multimedia Interface (HDMI) module, a Digital Visual Interface (DVI) module, a Super Video Graphics Array (SVGA) module, and/or a Video Graphics Array (VGA) module, and/or the like.

The processor 1132 may be connected to the USB interface 1138, which may include one or more software and/or hardware modules that provide additional features, functionality and/or wired and/or wireless connectivity. For example, the USB interface 1138 may include a universal serial bus (USB) port, and/or the like.

The processor 1132 may be connected to the optical interface 1140, which may include one or more software and/or hardware modules that provide additional features, functionality and/or wired and/or wireless connectivity. For example, the optical interface 1140 may include a read/write Compact Disc module, a read/write Digital Versatile Disc (DVD) module, and/or a read/write Blu-ray™ disc module, and/or the like.

The processor 1132 may be connected to the wireless interface 1142, which may include one or more software and/or hardware modules that provide additional features, functionality and/or wireless connectivity. For example, the wireless interface 1142 may include a Bluetooth® module, an Ultra-Wideband (UWB) module, a ZigBee module, and/or a Wi-Fi (IEEE 802.11) module, and/or the like.

In one or more techniques, device 1104, control system 16, and/or remote activation/access 76, at a remote location or otherwise, may (e.g., constantly) assess the fire hazard risk of one or more, or each, structure and/or region, perhaps based on the data (e.g, as described herein) available to device 1104, control system 16, and/or remote activation/access 76. Device 1104, control system 16, and/or remote activation/access 76 may be configured to determine which fire suppression system(s) to activate. Device 1104, control system 16, and/or remote activation/access 76 may be configured to (e.g., remotely) activate the determined fire suppression system(s). In one or more techniques, such activation may be automatic and/or may include supervisory input. For example, based on certain fire hazard risks, suppression system(s) may be activated upon detection of a fire burning within a certain radius of a system.

While the present embodiments have been described in terms of several illustrated embodiments, it will be appreciated by one of ordinary skill that the spirit and scope of the embodiments is not limited to those embodiments, but extend to the various modifications and equivalents as defined in the appended claims.

What is claimed is:

1. A method of protecting a structure from fire, the structure including a wildfire suppression system configured to protect the structure and a desired area around the structure from the fire, the method comprising:
determining that at least the structure is threatened by the fire based upon one or more factors; and
activating the fire suppression system from an activation location remote from the wildfire suppression system.

2. The method of claim 1, wherein the determining that at least the structure is threatened by the fire is performed at a determination location remote from the wildfire suppression system.

3. The method of claim 1, wherein the one or more factors include historical fire patterns for a region proximate to the structure.

4. The method of claim 1, wherein the one or more factors include fuel distribution patterns for a region proximate to the structure, the fuel distribution patterns comprising fuel distribution patterns of at least one of: vegetative plant communities, or patterns of structures.

5. The method of claim 1, wherein the one or more factors include a perimeter of an actively burning fire.

6. The method of claim 1, wherein the one or more factors include at least one of: smoke detection, flame detection, or fire gas detection.

7. The method of claim 1, wherein the one or more factors include at least one of: volumetric sensing, video imaging sensing, or multimodal object recognition.

8. The method of claim 1, wherein the one or more factors include an occurrence of one or more fires burning within a set radius from at least the structure.

9. The method of claim 1, wherein the activating includes remote access via a satellite link.

10. The method of claim 1, wherein the activating includes the use of an authorization code, the authorization code including at least one of: a fingerprint, or facial recognition.

11. The method of claim 1, wherein the activating is performed by a device configured to determine one or more activation triggers.

12. The method of claim 11, wherein the determining that the desired area is threatened by the fire based upon one or more factors is performed by the device.

13. The method of claim 11, further comprising:
providing the device with information and/or data;
the device performing a reconfiguration of itself using the information and/or data; and
the device determining adjusted one or more activation triggers based on the reconfiguration.

14. A method of protecting a structure from fire, the structure including a fire suppression system configured to protect the structure from the fire, the method comprising:
monitoring at least one of: a water supply pressure of the fire suppression system, or a water supply flow of the fire suppression system;
determining that a fire suppression system demand exceeds a threshold based on at least one of: the water supply pressure, or the water supply flow; and
changing a flow of a fire retardant of the fire suppression system to at least a first surface of the structure upon the determining the fire suppression system demand exceeds the threshold.

15. The method of claim 14, wherein the threshold corresponds to a hydraulic capacity of the fire suppression system.

16. The method of claim 14, wherein the changing the flow of the fire retardant to the first surface includes reducing the flow of the fire retardant to the first surface.

17. The method of claim 16, wherein the first surface is a vertical surface of the structure.

18. The method of claim 14, further comprising:
maintaining a flow of the fire retardant of the fire suppression system to at least a second surface of the structure upon the determining the fire suppression system demand exceeds the threshold.

19. The method of claim 18, wherein the second surface is a horizontal surface of the structure.

20. A method of protecting a plurality of structures from fire, each of the plurality of structures including a fire suppression system configured to protect each of the plurality of structures from the fire, the method comprising:
monitoring at least one of: a water supply pressure of one or more of the plurality of fire suppression systems, or a water supply flow of the one or more of the plurality of fire suppression systems;
determining that a fire suppression system demand for the one or more of the plurality of fire suppression systems exceeds a threshold based on at least one of: the water supply pressure of the one or more of the plurality of fire suppression systems, or the water supply flow of the one or more of the plurality of fire suppression systems;
determining which of the one or more of the plurality of fire suppression systems is directing a flow of fire retardant to at least one vertical surface of a structure respectively associated with the one or more of the plurality of fire suppression systems; and
changing the flow of fire retardant directed to the at least one vertical surface for each of the determined one or more of the plurality of fire suppression systems upon the determining the fire suppression system demand exceeds the threshold.

21. The method of claim 20, wherein the changing the flow of fire retardant directed to the at least one vertical surface for each of the determined one or more of the plurality of fire suppression systems includes reducing the flow of fire retardant directed to the at least one vertical surface for each of the determined one or more of the plurality of fire suppression systems.

22. The method of claim 20, further comprising:
determining which of the one or more of the plurality of fire suppression systems is directing a flow of fire retardant to at least one horizontal surface of a structure respectively associated with the one or more of the plurality of fire suppression systems; and
maintaining the flow of fire retardant directed to the at least one horizontal surface for each of the determined one or more of the plurality of fire suppression systems upon the determining the fire suppression system demand exceeds the threshold.

23. A method of protecting a plurality of structures from fire, each of the plurality of structures including a fire suppression system configured to protect each of the plurality of structures from the fire, the method comprising:
determining a first set of one or more of the fire suppression systems that are proximate to a perimeter of an active fire region;
determining a second set of one or more of the fire suppression systems that are more distant to the perimeter of the active fire region relative to the first set of the one of more fire suppression systems; and
changing a flow of fire retardant directed to the second set of one or more of the fire suppression systems.

24. The method of claim 23, wherein the changing the flow of fire retardant directed to the second set of one or more of the fire suppression systems includes reducing the flow of fire retardant directed to the second set of one or more of the fire suppression systems.

25. The method of claim 24, further comprising:
maintaining a flow of fire retardant directed to the first set of one or more of the fire suppression systems.

26. A method of estimating risk of exposure to fire for one or more regions of a geographic territory, the method comprising:
determining a first fire risk rank for at least one region of the one or more regions based on one or more current atmospheric conditions corresponding to the at least one region;
determining one or more fire characteristics of the at least one region based at least on one image of the at least one region, the at least one image captured after a temporally recent past fire in or near the at least one region;
determining a number of fire suppression systems located in or near the at least one region;
determining one or more ember hazard effects for the at least one region;
adjusting the first fire risk rank to a second fire risk rank based on one or more of: the number of fire suppression systems, the one or more ember hazard effects, or the one or more fire characteristics;
determining an evacuation condition based on the second fire risk rank; and
communicating the evacuation condition to one or more recipients.

27. The method of claim 26, wherein the evacuation condition includes determining an evacuation trigger threshold.

28. The method of claim 26, further comprising:
determining a recently extinguished fire impact on at least one structure in or near the at least one region;
performing a comparison of the recently extinguished fire impact on the at least one structure with the second fire risk rank;
determining a predicted hazard assessment for the at least one structure based on the comparison; and
communicating the predicted hazard assessment for the at least one structure to at least one party associated with the at least one structure.

29. The method of claim 26, further comprising:
determining one or more indicators of a current fire in or near the at least one region from an internet-based social media system; and
adjusting the second fire risk rank based on the one or more indicators.

30. The method of claim 26, wherein the one or more recipients are at least one of: a structure owner, a state government, a fire-fighting agency, a local government, a realtor, or an insurance broker.
